(19) United States
(12) Patent Application Publication
(10) Pub. No.: US 2023/0009212 A1
(43) Pub. Date: Jan. 12, 2023

(54) PROCESS DIGITIZATION SYSTEM AND METHOD

(71) Applicant: BEET, Inc., Southfield, MI (US)

(72) Inventors: David Jingqiu Wang, Northville, MI (US); Aaron Gregory Romain, Dearborn, MI (US); Daniel Philip Romain, Northville, MI (US); Po-Chao Lee, Northville, MI (US)

(73) Assignee: BEET, Inc., Southfield, MI (US)

(21) Appl. No.: 17/886,886

(22) Filed: Aug. 12, 2022

Related U.S. Application Data
(63) Continuation-in-part of application No. 16/957,604, filed on Jun. 24, 2020.
(60) Provisional application No. 63/233,178, filed on Aug. 13, 2021.
(60) Provisional application No. 62/621,709, filed on Jan. 25, 2018.
(60) Provisional application No. 62/621,623, filed on Jan. 25, 2018.

(51) Int. Cl. G01S 5/00; G01S 5/02; H04W 4/029

(52) U.S. Cl. CPC G01S 5/0027; G01S 5/02521; H04W 4/029

(57) ABSTRACT

A system and method for tracking actions of mobile assets used to perform a process within a facility includes a plurality of object trackers positioned throughout the facility to monitor, detect and digitize locations and actions, including movement, of a mobile asset within the facility. The mobile asset includes an identifier which is detectable by each object tracker to track the movement and location of the detected asset in real time. Each object tracker includes at least one sensor for monitoring and detecting the asset and its identifier, where the input sensed by the sensor is transmitted to a computer within the object tracker for time stamping with a detected time, and processing of the sensor input using one or more algorithms to identify the asset type associated with the detected identifier, and the asset's location in the facility at the detected time.

### CROSS-REFERENCE TO RELATED APPLICATIONS

This Application claims the benefit of U.S. Provisional Application 63/233,178 filed Aug. 13, 2021, U.S. patent application Ser. No. 16/957,604 filed Jun. 24, 2020, International Application PCT/US2019/014930 filed Jan. 24, 2019, U.S. Provisional Application 62/621,623 filed Jan. 25, 2018 and U.S. Provisional Application 62/621,709 filed Jan. 25, 2018, which are each hereby incorporated by reference in their entirety.

### TECHNICAL FIELD

The present disclosure relates to a system and method for tracking actions, including movement, of mobile assets which are used to perform a process within a facility.

### BACKGROUND

Material flow of component parts required to perform a process within a facility is one of the largest sources of down time in a manufacturing environment. Material flow of component parts is also one of the least digitized aspects of a process, as the dynamic nature of movement of component parts within a facility is complex and variable, requiring tracking of not only the direct productive parts such as workpieces and raw materials as these are moved and processed within the facility, but also requiring tracking of the carriers used to transport the workpieces and raw materials, which can include movement of the component parts by vehicles and/or human operators. Digitization of such an open-ended process with many component parts, carriers, and human interaction is very complex, and can be inherently abstract, for example, due to variability in the travel path of a component part through the facility, variety of carriers to transport the part, variability in human interaction in the movement process, etc. As such, it can be very difficult to collect data on material flow within a facility in a meaningful way. Without meaningful data collection, there is relatively minimal quantifiable analysis that can be done to identify sources of defects and delays and to identify opportunities for improvement in the movement and actioning of component parts within the facility, such that variation in movement of component parts within a facility is generally simply tolerated or compensated by adding additional and/or unnecessary lead time into the planned processing time of processes performed within the facility.

### SUMMARY

A system and method described herein provides a means for tracking and analyzing actions, including movements, of mobile assets used to perform a process within a facility, by utilizing a plurality of object trackers positioned throughout the facility to monitor, detect and digitize actions of the mobile asset within the facility. In a non-limiting example, the mobile asset can be identified by an identifier which is unique to that mobile asset and is detectable by each of the object trackers, such that an object tracker upon detecting the mobile asset can track the movement and location of the asset in real time. Each object tracker includes at least one sensor for monitoring and detecting the asset and asset identifier, where the sensor input sensed by the sensor is transmitted to a computer within the object tracker for time stamping with a detected time, and processing of the sensor input using one or more algorithms to identify the asset, including the asset ID and asset type associated with the identifier, the location of the asset in the facility at the detected time, and interactions of the asset at the detected time. Each object tracker is in communication via a facility network with a data broker such that the information detected by the object tracker, including the asset ID, asset type, detected time, detected location and detected interaction can be transmitted to the data broker as an action entry for that detection event and stored in a action list data structure associated with the detected asset. The computer within the object tracker can be referred to herein as a tracker computer. The sensor input can include, for example, sensed images, RFID signals, location input, etc., which is processed by the tracker computer to generate the action entry, where the action entry, in an illustrative example, is generated in JavaScript Object Notation (JSON), as a JSON string for transmission via the facility network to the data broker. Advantageously, by digitizing the sensor input for each detection event using the tracker computer of the object tracker (edge device), it is not necessary to transmit the sensor input over the facility network, and the amount of data transmitted via the facility network to the data broker for each detection event is substantially reduced. Accordingly, it is an objective of the system and methods disclosed herein to work within these limitations presented by the use of edge devices which are relatively small and low power, while still providing an acceptable level of data processing and information transmission. The system and methods described herein provide a means for tracking and analyzing actions, including movements, of mobile assets used to perform a process within a facility, using a plurality of edge devices configured as object trackers positioned throughout the facility to monitor, detect and digitize actions of the mobile asset within the facility by optimizing use of the computing capabilities of the edge devices. This requires both a software component and a manipulation of hardware and various environmental factors, including incorporating fiducials and object identifiers into the environment, in order to reduce the edge software workload. In an illustrative example, first, the hardware and environmental manipulation act as a first filter to reduce the “noise” in the data stream. Then secondly, the software can more easily and efficiently filter the rest of the data stream, in order to more effectively pick out the useful pieces of data, creating a good flow of information that can be passed along the network, where the information flowed along the network is useful data and reduced in volume from the unfiltered, initial data stream received by the edge device.

As the asset is moved and/or acted upon within the facility through a sequence of actions, the object trackers continue to detect the asset and report information collected during each detection event to the data broker, such that the collected data can be analyzed by a data analyzer, also referred to herein as an analyst, for example, to determine an actual duration of each movement and/or action of the mobile asset during processing within the facility, to identify a sequence of movements and/or actions, to map the location of the asset at the detected time and/or over time to a facility map, to compare the actual duration with a baseline duration, and/or to identify opportunities for improving asset flow in the facility, including opportunities to reduce the duration of each movement and/or action to improve, e.g., reduce processing time and/or increase throughput and productivity of the process. Advantageously, the system and method can use the collected data to generate visualization outputs, including, for example, a detailed map of the facility tracking the movement of assets over time, and a heartbeat for the asset using the actual and/or baseline durations of sequential movements and actions of the asset within the facility. The visualization outputs can be displayed, for example, via a user device in communication with the analyst.

By way of illustration, the system and method are described herein using a non-limiting example where the mobile assets being tracked and analyzed include part carriers and component parts. In a non-limiting example, the actions of a mobile asset which are detected and tracked by the object trackers can include movement, e.g., motion, of the mobile asset, including transporting, lifting, and placing a mobile asset. In the illustrative example, the actions detected can include removing a component part from a part carrier, and/or moving a component part to a part carrier. A component part, as that term is used herein, refers to a component which is used to perform a process within a facility. In a non-limiting illustrative example, a component part, also referred to herein as a part, can be configured as one or more of a workpiece, an assembly including the workpiece, raw material used in forming the workpiece or assembly, and/or a tool, a gage, a fixture, or other component which is used in the process performed within the facility. A part carrier refers to a carrier which is used to move a component part within the facility. In a non-limiting illustrative example, a part carrier, also referred to herein as a carrier, can include any asset used to move or action a component part, including, for example, containers, bins, pallets, trays, etc. which are used to contain or support a component part during movement or actioning of the component part in the facility, and further including any mobile asset used to transport the container, bin, pallet, tray etc., and/or the component part or parts, including, for example, vehicles including lift trucks, forklifts, pallet jacks, automatically guided vehicles (AGVs), carts, and people such as machine operators and material handling personnel used to move and/or action a component part and/or a carrier for transporting a component part.

In one example, the sensor input can be used by the tracker computer to determine one or more interactions of the detected asset. For example, where the detected asset is a first part carrier being conveyed by a second part carrier, an interaction determined by the tracker computer can be the asset ID and the asset type of the second part carrier being used to convey the first part carrier. For example, the first part carrier can be a part tray being transported by an AGV, where the detected asset is the part tray, and the interaction is the asset ID and asset type of the AGV. Another interaction can be, for example, a quantification of the number, type, and/or condition of parts being transported on the parts tray, using image sensor input of the first part carrier received by the object tracker, where the part condition, in one example, can include a part parameter such as an identifying dimension, feature, or other parameter determinable by the object tracker from the image sensor input. Advantageously, using the asset list entries of the sequenced actions of an asset, including location over time and interaction data, block chain traceability of component parts through processing can be determined from the action list data structure for that asset.

A method for tracking actions of mobile assets used to perform a process within a facility is provided. The method can include positioning an object tracker at a tracker location within the facility, and providing a plurality of mobile assets to the facility, where each mobile asset includes an identifier which is unique to the mobile asset. The mobile asset is associated in a database with the identifier, an asset ID and an asset type. The object tracker defines a detection zone relative to the tracker location. The object tracker includes a sensor configured to collect sensor input within the detection zone, where collecting the sensor input includes detecting the identifier when the mobile asset is located in the detection zone. The object tracker further includes a tracker computer in communication with the sensor to receive the sensor input, and at least one algorithm for performing time stamping of the sensor input with a detection time, processing the sensor input to identify the identifier, processing the identifier to identify the asset ID and the asset type associated with the identifier and generating an asset entry including the asset ID, the asset type, and the detection time.

The method further includes collecting, via the sensor, the sensor input, receiving, via the tracker computer, the sensor input, time stamping, via the tracker computer, the sensor input with a detection time, processing, via the tracker computer, the sensor input to identify the identifier, processing, via the tracker computer, the identifier to identify the asset ID and the asset type associated with the identifier, and generating, via the tracker computer, the asset entry. The method can further include digitizing the asset entry using the object tracker, the tracker computer of the object tracker being in communication with a central data broker via a network, transmitting the asset entry to the central data broker via the network, mapping the asset entry to an asset action list using the central data broker, and storing the asset action list to the database, where the asset entry and the asset action list are each associated with the asset ID and asset type associated with the identifier. The method can include analyzing, via an analyst in communication with the database, the asset action list, where analyzing the asset action list can include determining an action event defined by the asset action list and determining an action event duration of the action event. The method can further include generating, via the analyst, one or more visualization outputs. For example, the method can include generating, via the analyst, a tracking map defined by the asset action list, wherein the tracking map visually displays at least one action performed by the mobile asset associated via the asset ID and asset type with the asset action list. The method can further include generating, via the analyst, a virtual representation of the mobile asset in the facility, which can include showing virtual movement of a virtual mobile asset defined by the action events and action durations detected for the mobile asset. The virtual representation can include a tracking map. Other information, such as the heartbeat display, may be displayed concurrently with the virtual representation. The method can further include generating, via the analyst, a heartbeat defined by the asset action list, where the heartbeat visually displays the action event duration and the action event. In one example, analyzing the asset action list includes determining a plurality of action events defined by the asset action list, determining a respective action event duration for each action event of the plurality of action events, ordering the plurality of action events in a sequence according to time of occurrence, and generating, via the analyst, the heartbeat, where the heartbeat visually displays the respective action event duration and the action event of each of the plurality of action events in the sequence.

A method for identifying the pose and location of a mobile asset in the facility is provided. In one example, the identifier includes a first reference point at a first known position and a second reference point at a second known position such that the first reference point is located at a known distance from the second reference point, and the sensor input includes an image of the mobile asset including the identifier. The method for identifying the pose of the mobile asset includes analyzing, via the tracker computer, the image of the mobile asset including the identifier to determine a pose of the mobile asset at the detection time, where analyzing the image includes determining a first image position of the first reference point in the image, determining a second image position of the second reference point in the image, determining an image distance between the first image position and the second image position, comparing the image distance and the known distance, and determining a facing direction of the identifier using the comparison of the image distance and the known distance. The method can further include determining a facing direction of the mobile asset using the facing direction of the identifier, determining an observed dimension of an asset feature of the mobile asset from the image of the mobile asset, comparing the observed dimension of the asset feature and a known asset dimension of the asset feature, and determining the location of the mobile asset in the facility, using the comparison of the observed dimension and the known asset dimension.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic perspective illustration of a facility including a system including a plurality of object trackers for tracking and analyzing actions of mobile assets used in performing a process within the facility;

FIG. 2 is a schematic top view of a portion of the facility and system of FIG. 1;

FIG. 3 is a schematic partial illustration of the system of FIG. 1 showing detection zones defined by the plurality of object trackers;

FIG. 4 is a schematic partial illustration of the system of FIG. 1 including a schematic illustration of an object tracker;

FIG. 5 is a perspective schematic view of an exemplary mobile asset configured as a part carrier and including at least one asset identifier;

FIG. 6 is a perspective schematic view of an exemplary mobile asset configured as a component part and including at least one asset identifier;

FIG. 7 is a schematic illustration of an example data flow and example data structure for the system of FIG. 1;

FIG. 8 is a schematic illustration of an example asset action list included in the data structure of FIG. 7;

FIG. 9 is a method of tracking and analyzing actions of mobile assets using the system of FIG. 1;

FIG. 10 is an example visualization output of a heartbeat generated by the system of FIG. 1, for sequence of actions taken by a mobile asset;

FIG. 11 is a schematic illustration of an environment, such as the facility of FIG. 1 including a plurality of mobile assets, showing an environmental manipulation including applications of object identifiers to the mobile assets and to a fixed asset of the facility;

FIG. 12 is a schematic illustration of exemplary object identifiers each configured in a standardized shape and/or pattern such that the standardized shape when attached to a mobile asset in a known position defines a fiducial marking;

FIG. 13 is a schematic illustration of a method of in-situ object detection training of the plurality of object trackers of FIG. 1, the method utilizing one of the object trackers as a master edge device;

FIG. 14 is a schematic illustration of a method of operator identification of an operator within a detection zone of the plurality of object trackers of FIG. 1, the method utilizing one of the object trackers as a master edge device;

FIG. 15 is a schematic illustration demonstrating a method of pose detection of a mobile asset using a standardized object identifier affixed to and/or defined by the mobile asset;

FIG. 16 is a schematic illustration demonstrating a method for sensor localization training based on a shared learned mobile asset using the system of FIG. 1;

FIG. 17 is a schematic illustration demonstrating a method for fitting data collected via the object trackers of the system of FIG. 1 to a sequence of operations performed by the mobile assets; and

FIG. 18 is a schematic illustration of a visualization display generated by the system of FIG. 1 using image data collected from the object trackers, the visualization display including a virtual reconstruction of mobile assets located and/or moving in the facility and in the example shown further including a sequence of operations heartbeat display.

### DETAILED DESCRIPTION

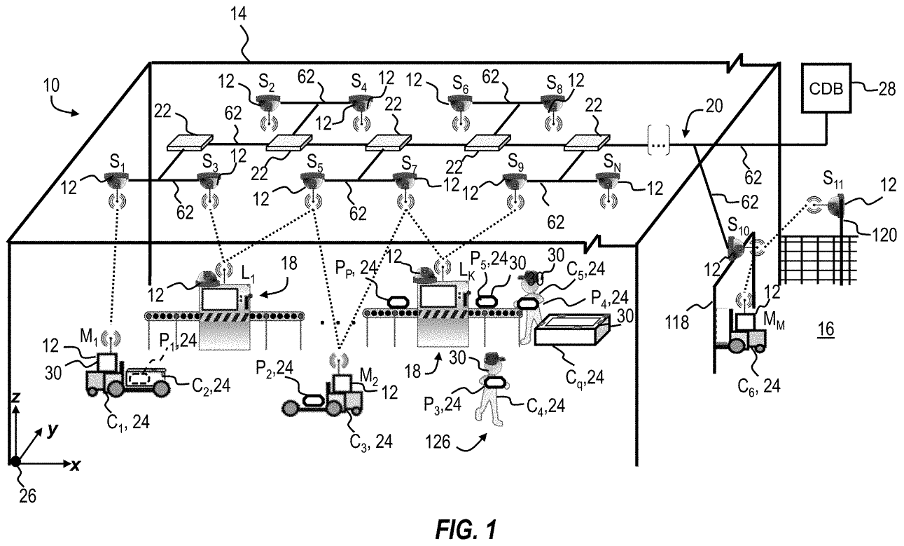

The elements of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein. Referring to the drawings wherein like reference numbers represent like components throughout the several figures, the elements shown in FIGS. 1-10 are not necessarily to scale or proportion. Accordingly, the particular dimensions and applications provided in the drawings presented herein are not to be considered limiting.

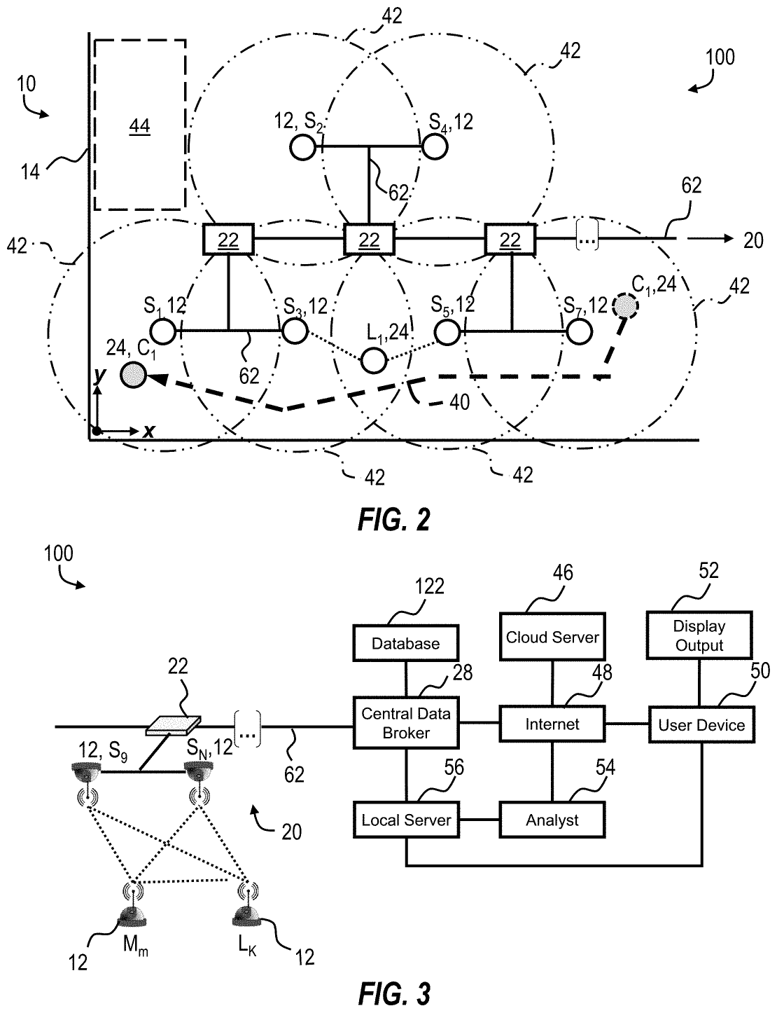

Referring to FIGS. 1-10, a system 100 and a method 200, as described in additional detail herein, are provided for tracking and analyzing actions of mobile assets 24 used to perform a process within a facility 10, utilizing a plurality of object trackers 12 positioned throughout the facility 10 to monitor, detect and digitize the actions of the mobile assets 24 within the facility 10, where the actions include movement of the mobile assets 24 within the facility 10. An object tracker 12 can also be referred to herein as an edge device. A mobile asset 24 can also be referred to herein as an object 24 or as an asset 24. Each mobile asset 24 includes an identifier 30 and is assigned an asset identification (asset ID) 86 and an asset type 88. The asset ID 86 and asset type 88 for a mobile asset 24 are stored as an asset instance 104 associated with an asset description 84 of the mobile asset 24 in a database 122. In a non-limiting example, each mobile asset 24 includes and can be identified by an identifier 30 which is detectable by the object tracker 12 when the mobile asset 24 is located within a detection zone 42 defined by that object tracker 12 (see FIG. 2), such that an object tracker 12, upon detecting the mobile asset 24 in its detection zone 42 can track the movement and location of the detected mobile asset 24 in the detection zone 42 of that object tracker 12, in real time. The identifier 30 of a mobile asset 24 is associated with the asset instance 104, e.g., with the asset ID 86 and/or asset type 88, in the database 122, such that the object tracker 12, by identifying the identifier 30 of a detected mobile asset 24, can identify the asset ID 86 and/or the asset type 88 of the detected mobile asset 24. Each object tracker includes at least one sensor 64 for monitoring the detection zone 42 and detecting the presence of a mobile asset 24 and/or asset identifier 30 in the detection zone 42, where sensor input sensed by the sensor 64 is transmitted to a computer 60 within the object tracker 12 for time stamping with a detected time 92, and processing of the sensor input using one or more algorithms 70 to identify the detected identifier 30, to identify the detected mobile asset 24, including the asset ID 86 and asset type 88, associated with the identifier 30, to determine the location 96 of the asset 24 in the facility 10 at the detected time 92, and to determine one or more interactions 98 of the asset 24 at the detected time 92.

Each object tracker 12 is in communication via a facility network 20 with a central data broker 28 such that the asset information detected by the object tracker 12, including the asset ID 86, asset type 88, detected time 92, detected action type 94, detected location 96 and detected interaction(s) 98 can be transmitted to the central data broker 28 as an action entry 90 for that detection event and stored to an action list data structure 102 associated with the detected asset 24. The computer 60 within the object tracker 12 can be referred to herein as a tracker computer 60. The sensor input received from one or more sensors 64 included in the object tracker 12 can include, for example, sensed images including images of identifiers 30, fiducial marks 36, mobile assets 24 including parts P, carriers C, persons 125 such as operators performing processes, RFID signals, location input, etc., which is processed by the tracker computer 60 to generate the action entry 90 for each detected event, where the action entry 90 is a digitized entry which is digitized by the tracker computer 60. The digitized action entry 90, in an illustrative example, is generated in JavaScript Object Notation (JSON), for example, by serializing the action entry data into a JSON string for transmission as an action entry 90 via the facility network 20 to the data broker 28. Advantageously, by digitizing the sensor input processed for each detection event into an action entry 90, using the tracker computer 60, it is not necessary to transmit the unprocessed sensor input over the facility network 20, and the amount of data required to be transmitted via the facility network 20 to the data broker 28 for each detection event is substantially reduced and simplified in structure. Accordingly, an objective of the system 100 and methods disclosed herein is to work within the limitations presented by the use of edge devices which are relatively small and low power, while still providing an acceptable level of data processing and information transmission operable to detect and determine the movement and location of objects within a facility. The system 100 and methods described herein provide a means for tracking and analyzing actions, including movements, of mobile assets 24, for example, during use of the mobile assets 24 to perform a process within a facility 10, using a plurality of edge devices configured as object trackers 12 positioned throughout the facility to monitor, detect and digitize actions of the mobile assets 24 within the facility 10 by optimizing use of the computing capabilities of the edge devices 12. This requires both a software component and a manipulation of hardware and various environmental factors, including incorporating fiducials 36 and object identifiers 30 into the facility environment, in order to reduce the edge software workload performed by a tracker computer 60 of an object tracker 12. In an illustrative example, first, hardware and environmental manipulation, including configuring a plurality of object trackers 12 within a facility, and associating and/or defining at least one identifier 30 with each mobile asset 24, acts as a first filter to reduce the “noise” in the data stream collected by each object tracker 12. Then secondly, the tracker computer 60 and software and algorithms included in the object tracker 12 (edge device) can more easily and efficiently filter the rest of the data stream collected by the object tracker 12, in order to more effectively pick out the useful pieces of data, to identify mobile assets 24 and their movements detected by the object tracker 12, and digitizing the useful pieces of the data, such as a location in the facility 10 of a mobile asset 24 at a detection time, creating a good flow of information that can be passed along the network 20, where the information flowed along the network 20 is filtered to include only useful data and digitized such that the information flowed along the network 20 is reduced in volume from the unfiltered, initial data stream received by the object tracker 12 (edge device).

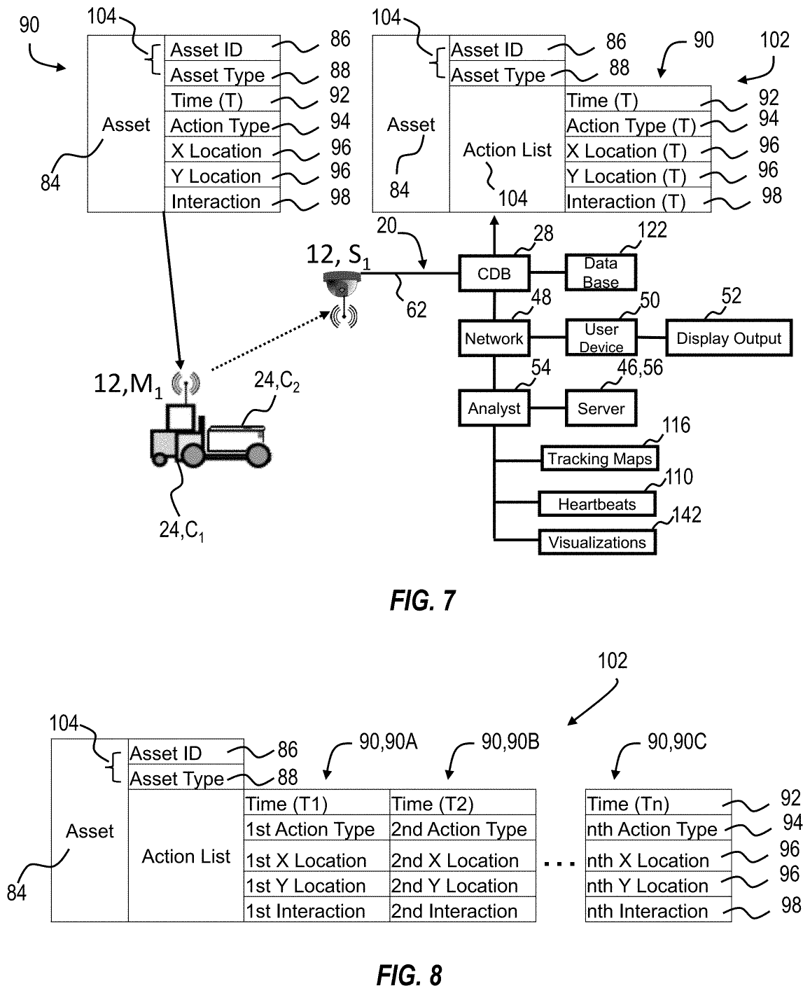

Referring to the example system 100 shown in FIG. 1, as the mobile asset 24 is moved through a sequence of actions 114 within the facility 10, the various object trackers 12 positioned within the facility 10 continue to detect the mobile asset 24, collect sensor input during each additional detection event, to process the sensor input to generate an additional action entry 90 for the detection event, and transmit the additional action entry 90 to the central data broker 28. The central data broker 28, upon receiving the additional action entry 90, deserializes the action entry data, which includes an asset ID 86 identifying the mobile asset 24, and maps the data retrieved from the additional action entry 90 to a data structure configured as an asset action list 102 associated with the mobile asset 24 identified in the action entry 90, as shown in FIG. 7. The asset action list 102, updated to include the data from the additional action entry 90, is stored to a database 122 in communication with the central data broker 28, as shown in FIGS. 3, 4 and 7. In a non-limiting example, the database 122 can be stored to one of the central data broker 28, a local server 56, or remote server 46.

In one example, the remote server 46 is configured as a cloud server accessible via a network 48 in communication with the remote server 46 and the central data broker 28. In one example, the network 48 is the Internet. The server 46, 56 can be configured to receive and store asset data and action data to the database 122, including for example, identifier 30 data, asset instance 104 data, asset entry 90 data, and asset action list 102 data for each mobile asset 24, in a data structure as described herein. The server 46 can be configured to receive and store visualization outputs including, for example, tracking maps 116 and mobile asset heartbeats 110 generated by an analyst 54 in communication with the server 46, 56, using the action data. The analyst 54 includes a central processing unit (CPU) 66 for executing one or more algorithms for analyzing the data stored in the database 122, and a memory, The analyst 54 can include, for example, algorithms for analyzing the asset action lists 102, for determining asset event durations 108, for generating and analyzing visualization outputs including asset event heartbeats 110 and tracking maps 116, etc. The memory, at least some of which is tangible and non-transitory, may include, by way of example, ROM, RAM, EEPROM, etc., of a size and speed sufficient, for example, for executing the algorithms, storing a database, and/or communicating with the central data broker 28, the servers 46, 56, the network 48, one or more user devices 50 and/or one or more output displays 52.

The server 46, 56 includes one or more applications and a memory for receiving, storing, and/or providing the asset data, action data and data derived therefrom including visualization data, heartbeat data, map data, etc. within the system 100, and a central processing unit (CPU) for executing the applications. The memory, at least some of which is tangible and non-transitory, may include, by way of example, ROM, RAM, EEPROM, etc., of a size and speed sufficient, for example, for executing the applications, storing a database, which can be the database 122, and/or communicating with the central data broker 28, the analyst 54, the network 48, one or more user devices 50 and/or one or more output displays 52. The analyst 54, also referred to herein as a data analyzer, is in communication with the server 46, 56, and analyzes the data stored to the asset action list 102, for example, to determine an actual duration 108 of each action and/or movement of the mobile asset 24, during processing within the facility 10, to identify a sequence 114 of action events 40 defined by the movements and/or actions, to map the location of the mobile asset 24 at the detected time 92 and/or over time to a facility map 116, to compare the actual action event duration 108 with a baseline action event duration, and/or to identify opportunities for improving asset movement efficiency and flow in the facility 10, including opportunities to reduce the action duration 108 of each movement and/or action to improve the effectiveness of the process by, for example, reducing processing time and/or increasing throughput and productivity of the process. Advantageously, the system 100 and method 200 can use the data stored in the database 122 to generate visualization outputs, including, for example, a detailed map 116 of the facility 10, showing the tracked movement of the mobile assets 24 over time, and a heartbeat 110 for action events 40 of an asset 24, using the action durations 108 of sequential movements and actions of the asset 24 within the facility 10. The visualization outputs can be displayed, for example, via a user device 50 and/or an output display 52 in communication with the analyst 54.

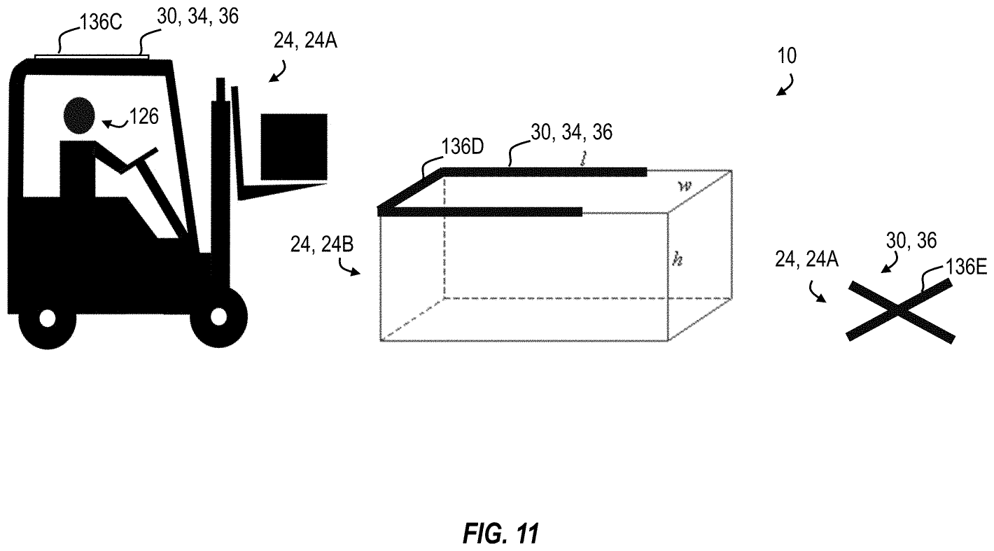

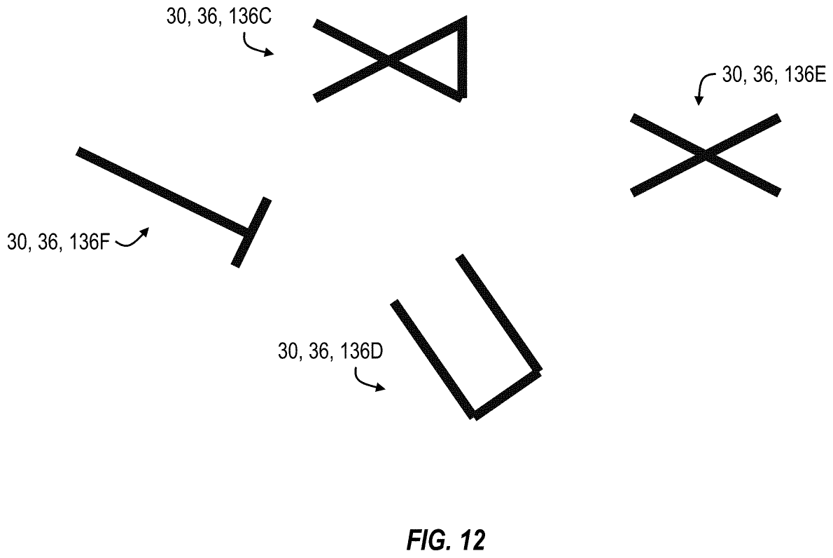

Referring to FIGS. 11-18, FIG. 11 is a schematic illustration of an environment, such as a facility 10, including a plurality of objects 24, also referred to herein as assets or mobile assets, showing an environmental manipulation including an application of identifiers 30 to the objects 24 to define a fiducial 36. In the example shown, each identifier 30 is made of a retro-reflective material applied in a shape or pattern 136 (see FIG. 12) where the retro-reflective material returns (reflects) the light emitted by the light sources 72 to the object tracker 12 such that the reflected light is detected by the sensor S 64 of the object tracker 24, which detects the image of the shape or pattern 126 of the identifier.

FIG. 12 is a schematic illustration of exemplary object identifiers 30, each identifier 30 including retro-reflective material configured in a standardized shape and/or pattern 136 such that retro-reflective material in the standardized shape comprises a fiducial 36. FIG. 12 elaborates on FIG. 11 to demonstrate a method using the retro-reflective material applied in the standardized shape and/or pattern 136 to form an identifier 30 which generates a standardized image, such that when sensed by the sensor S 64, the object tracker edge device 12 uses a relatively reduced amount of computing power of the tracker computer 60 to detect, identify and/or process the image(s) of the standardized shape 136, the identifier 30, and/or the object 24 to which the identifier 30 is affixed.

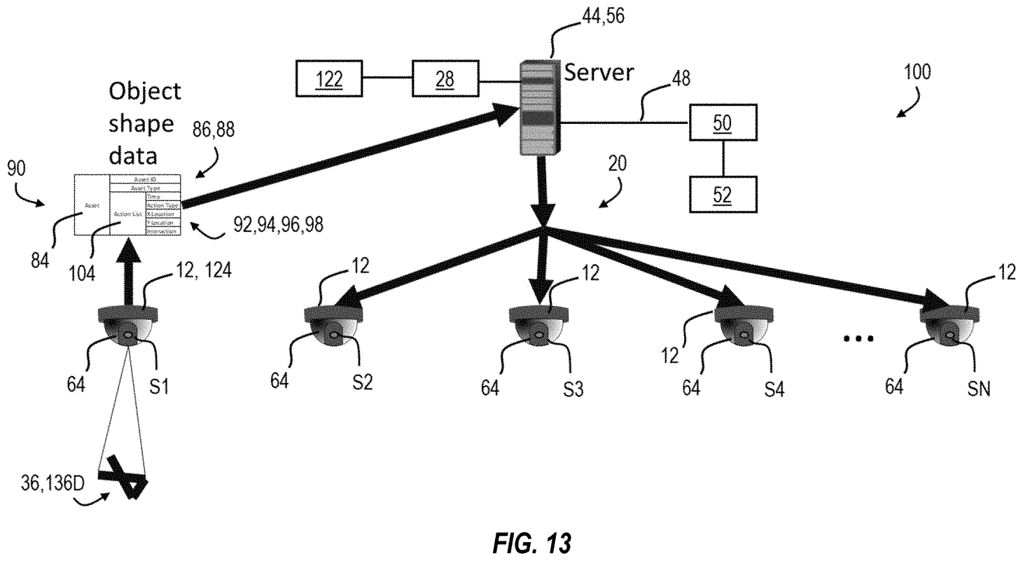

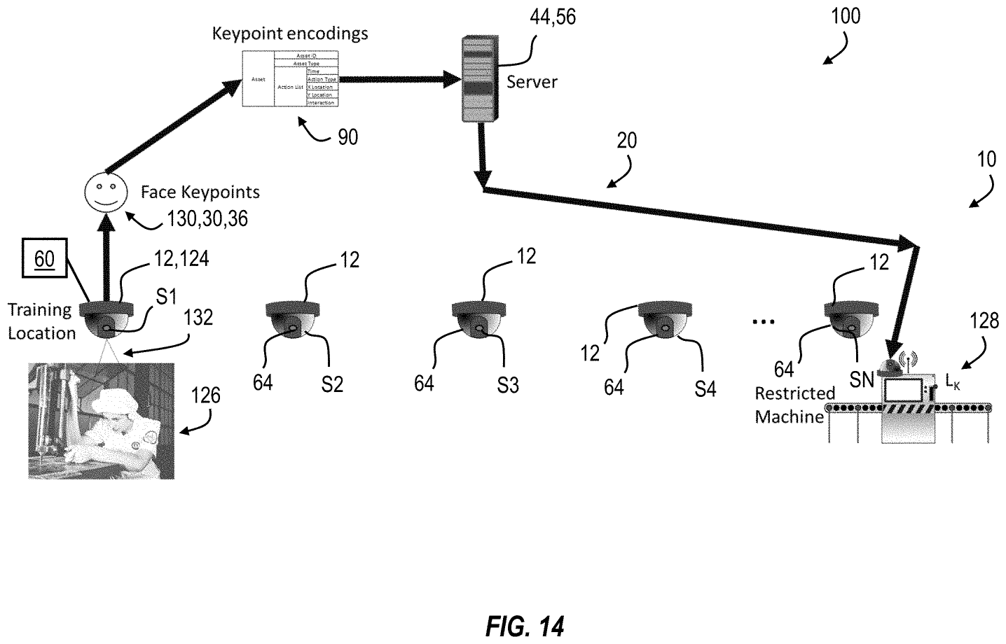

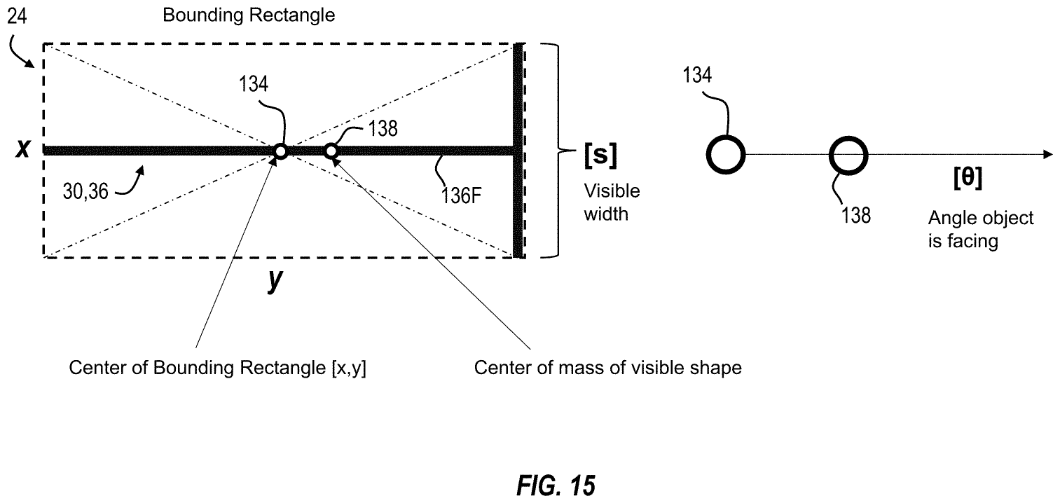

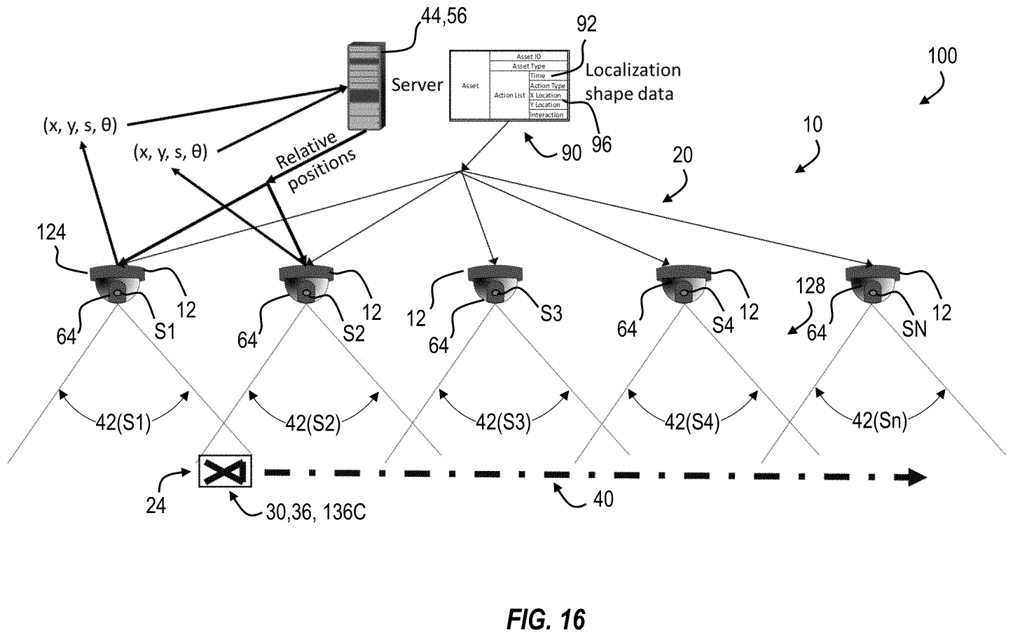

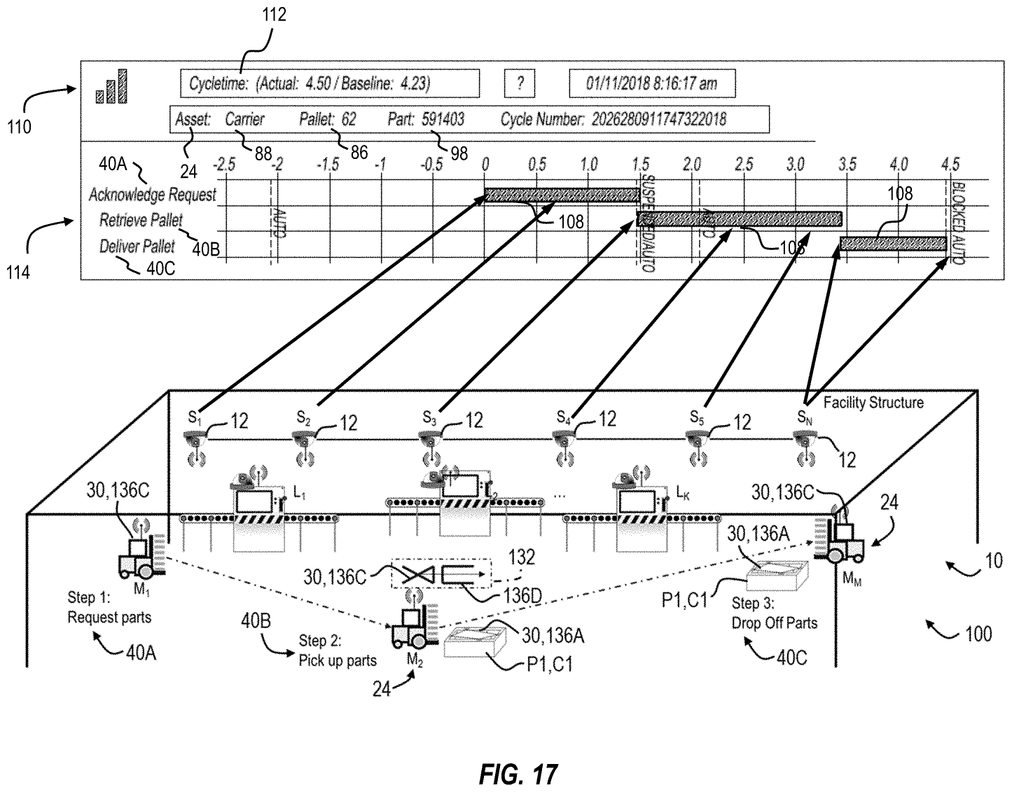

Referring again to the drawings, and as further described herein, FIG. 13 illustrates a method of in-situ object detection training for a network of object tracker edge devices 12 within a facility 10, using one object tracker 12 as a master edge device 124. FIG. 14 illustrates a method for operator identification of an operator (person) 126 at the edge, e.g., within the detection zone 42 of master object tracker edge device 124. FIG. 15 illustrates a method of pose detection of an object 24 using a standardized object identifier 30, e.g., an identifier 30 having a standardized shape and/or pattern 136, where the standardized identifier 30 is positioned on the object 24 in a known location and orientation relative to the object (mobile asset) 24. FIG. 16 illustrates a method for sensor localization training using a shared learned object 24 moving through detection zones 42 of a plurality of object trackers 12. FIG. 17 illustrates a method for fitting data collected via the object trackers 12 to a sequence of operations 114 performed by the objects 24, where the sequence of operations 114 can also be referred to herein as a sequence of action events 114.

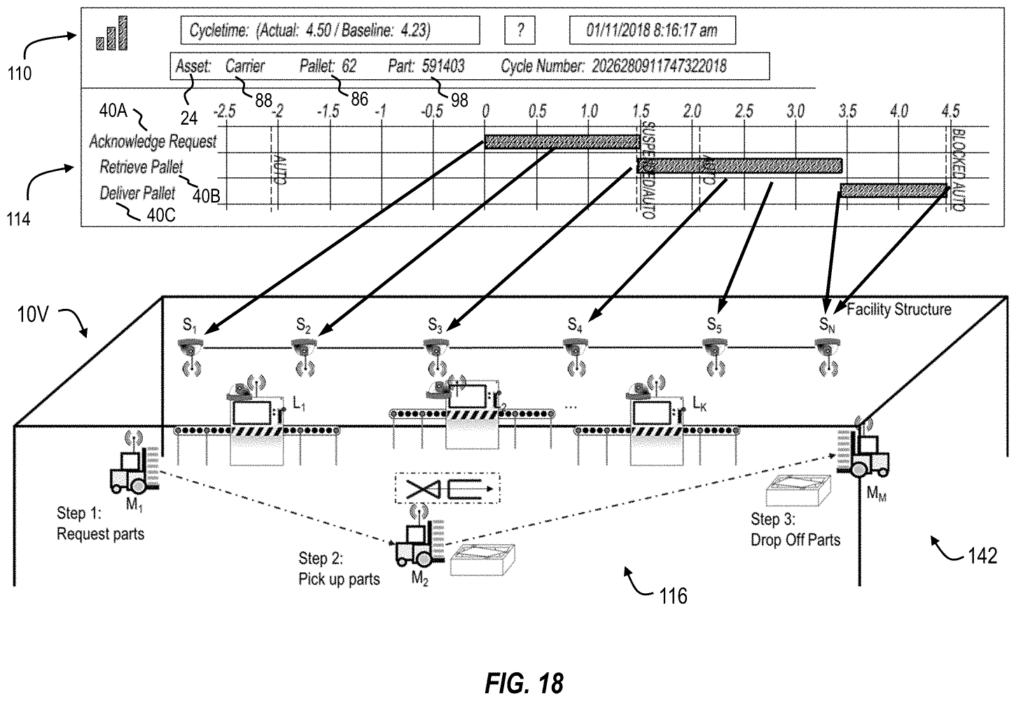

FIG. 18 is a schematic illustration of a visualization display 142 generated by the system 100, the visualization display 142 including, in a non-limiting example, a virtual reconstruction 10V of the facility 10 and a virtual reconstruction of mobile assets 24 shown where located in the facility 10 at the detection time corresponding to the displayed virtual reconstructions 10V. In one example, the virtual reconstruction 142 may be animated to show movement of the mobile assets 24 within the facility 10 during a period of detection times. In one example, the virtual reconstruction 142 can include a tracking map 116 showing a path of movement of a mobile asset 24 in the facility 10. In the non-limiting example shown in FIG. 18, a sequence of operations 114 including a heartbeat display 110 can be concurrently displayed with the visualization display 142, the heartbeat display including a detection time period represented by the visualization display 142.

Again referring to FIGS. 1-8, an illustrative example of the system 100 for tracking and analyzing actions of mobile assets 24 used to perform a process within a facility 10 is shown. The facility 10 can include one or more structural enclosures 14 and/or one or more exterior structures 16. In one example, the performance of a process within the facility 10 can require movement of one or more mobile assets 24 within the structural enclosure 14, in the exterior structure 16, and/or between the structural enclosure 14 and the exterior structure 16. In the illustrative example shown in FIG. 1, the facility 10 is configured as a production facility including at least one structural enclosure 14 configured as a production building containing at least one processing line 18, and at least one exterior structure 16 configured as a storage lot including a fence 120. In the example, access for moving mobile assets 24 between the structural enclosure 14 and the exterior structure 16 is provided via a door 118. The example is non-limiting, and the facility 10 can include additional structural enclosures 14, such as additional production buildings and warehouses, and additional exterior structures 16.

The system 100 includes a plurality of object trackers 12 positioned throughout the facility 10 to monitor, detect and digitize the actions of one or more of the mobile assets 24 used in performing at least one process within the facility 10. Each object tracker 12 is characterized by a detection zone 42 (see FIG. 2), wherein the object tracker 12 is configured to monitor the detection zone 42 using one or more sensors 64 included in the object tracker 12, such that the object tracker 12 can sense and/or detect a mobile asset 24 when the mobile asset 24 is within the detection zone 42 of that object tracker 12. As shown in FIG. 2, an object tracker 12 can be positioned within the facility 10 such that the detection zone 42 of the object tracker 12 overlaps with a detection zone 42 of at least one other object tracker 12. Each of the object trackers 12 is in communication with a facility network 20, which can be, for example, a local area network (LAN). The object tracker 12 can be connected to the facility network 20 via a wired connection, for example, via an Ethernet cable 62, for communication with the facility network 20. In an illustrative example, the Ethernet cable 62 is a Power over Ethernet (PoE) cable, and the object tracker 12 is powered by electricity transmitted via the PoE cable 62. The object tracker 12 can be in wireless communication with the facility network 20, for example, via WiFi or Bluetooth®.

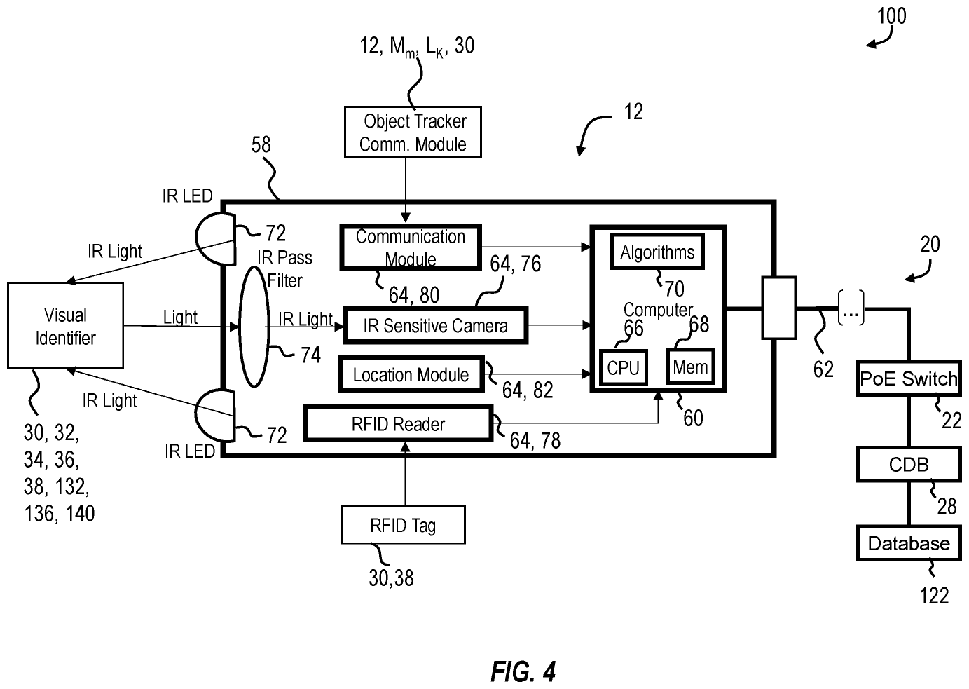

Referring again to FIG. 1, the plurality of object trackers 12 can include a combination of structural object trackers S₁ . . . S_{N}, line object trackers L_{I} . . . L_{K}, and mobile object trackers M₁ . . . M_{M}, where each of these is can be configured substantially as shown in FIG. 4, however may be differentiated in some functions based on the type (S, L, M) of object tracker 12. Each of the object trackers 12 can be identified by a tracker ID, which in a non-limiting example can be an IP address of the object tracker 12. The IP address of the object tracker 12 can be stored in the database 122 and associated in the database 122 with one or more of a type (S, L, M) of object tracker 12, and a location of the object tracker 12 in the facility 10. In one example, the tracker ID can be transmitted with the data transmitted by an object tracker 12 to the central data broker 28, such that the central data broker can identify the object tracker 12 transmitting the data, and/or associate the transmitted data with that object tracker 12 and/or tracker ID in the database 122. The structural (S), line (L) and mobile (M) types of the object trackers 12 can be differentiated by the position of the object tracker 12 in the facility 10, whether the object tracker 12 is in a fixed position or is mobile, by the method by which the location of the object tracker is determined, and/or by the method by which the object tracker 12 transmits data to a facility network 20, as described in further detail herein. As used herein, a structural object tracker S_{X} refers generally to one of the structural object trackers S₁ . . . S_{N}, a line object tracker L_{X} refers generally to one of the line object trackers L₁ . . . L_{K}, and a mobile object tracker M_{X} refers generally to one of the mobile object trackers M₁ . . . M_{M}.

Each of the object trackers 12 includes a communication module 80 such that each structural object tracker S_{X}, each line object tracker L_{X}, and each mobile object tracker M_{X} can communicate wirelessly with each other object tracker 12, for example, using WiFi and/or Bluetooth®. Each of the object trackers 12 includes a connector for connecting via a PoE cable 62 such that each structural object tracker S_{X}, each line object tracker L_{X}, and each mobile object tracker M_{X} can, when connected to the facility network 20, communicate via the facility network 20 with each other object tracker 12 connected to the facility network 20. Referring to FIG. 1, the plurality of object trackers 12 in the illustrative example include a combination of structural object trackers line object trackers L₁ . . . L_{K}, and mobile object trackers M₁ . . . M_{M}.

Each structural object tracker S_{X} is connected to one of the structural enclosure 14 or the exterior structure 16, such that each structural object tracker S_{X} is in a fixed position in a known location relative to the facility 10 when in operation. In a non-limiting example shown in FIG. 1, the location of each of the structural object trackers S₁ . . . S_{N} positioned in the facility 10 can be expressed as in terms of XYZ coordinates, relative to a set of X-Y-Z reference axes and reference point 26 defined for the facility 10. The example is non-limiting and other methods of defining the location of each of the structural object trackers S₁ . . . S_{N} positioned in the facility 10 can be used, including, for example, GPS coordinates, etc. The location of each of the structural object trackers S₁ . . . S_{N} can be associated with the tracked ID of the object tracker 12, and saved in the database 122. In the illustrative example, a plurality of structural object trackers S_{X} are positioned within the structural enclosure 14, distributed across and connected to the ceiling of the of the structural enclosure 14. The structural object trackers S_{X} can be connected by any means appropriate to retain each of the structural object trackers S_{X} in position and at the known location associated with that structural object trackers S_{X}. For example, a structural object tracker S_{X} can be attached to the ceiling, roof joists, etc., by direct attachment, by suspension from an attaching member such as a cable or bracket, and the like. In the example shown in FIGS. 1 and 2, the structural object trackers S_{X} are distributed in an X-Y plane across the ceiling of the structural enclosure 14 such that the detection zone 42 (see FIG. 2) of each one of the structural object trackers S₁ . . . S_{N} overlaps a detection zone 42 of at least one other detection zone 42 of the structural object trackers S₁ . . . S_{N}, as shown in FIG. 2. The structural object trackers S_{X} are preferably distributed in the facility 10 such that each area where it is anticipated that a mobile asset 24 may be present is covered by a detection zone 42 of at least one of the structural object trackers S. For example, referring to FIG. 1, a structural object tracker S_{X} can be located on the structural enclosure 14 at the door 118, to monitor the movement of mobile assets 24 into and out of the structural enclosure 14. One or more structural object trackers S_{X} can be located in the exterior structure 16, for example, positioned on fences 122, gates, mounting poles, light posts, etc., as shown in FIG. 1, to monitor the movement of mobile assets in the exterior structure 16.

As shown in FIG. 2, the facility 10 can include one or more secondary areas 44 where it is not anticipated that a mobile asset 24 may be present, for example, an office area, and/or where installation of a structural object tracker S_{X} is infeasible. These secondary areas 44 can be monitored, for example and if necessary, using one or more mobile object trackers M. In the illustrative example, each structural object tracker S_{X} is connected to the facility network 20 via an PoE cable 62 such that the each structural object tracker S_{X} is powered via the PoE cable 62 and can communicate with the facility network 20 via the PoE cable 62. As shown in FIGS. 1 and 2, the facility network 20 can include one or more PoE switches 22 for connecting two or more of the object trackers 12 to the facility network 20.

Each line object tracker L_{X} is connected to one of processing lines 18, such that each line object tracker L_{X} is in a fixed position in a known location relative to the processing line 18 when in operation. In a non-limiting example shown in FIG. 1, the location of each line object tracker L_{X} positioned in the facility 10 can be expressed as in terms of XYZ coordinates, relative to a set of X-Y-Z reference axes and reference point 26 defined for the facility 10. The example is non-limiting and other methods of defining the location of each line object tracker L_{X} positioned in the facility 10 can be used, including, for example, GPS coordinates, etc. The location of each of the line object tracker L_{X} can be associated with the tracked ID of the object tracker 12, and saved in the database 122. In the illustrative example, one or more line object trackers L_{X} are positioned on each processing line 18 such that the detection zone(s) 42 of the one or more line object trackers L_{X} extend substantially over the processing line 18 to monitor and track the actions of mobile assets 24 used in performing the process performed by the processing line 18. Each line object tracker L_{X} can be connected by any means appropriate to retain the line object tracker L_{X} in a position relative to the process lining line 18 and at the known location associated with that line object tracker L_{X} in the database 122. For example, a line object tracker L_{X} can be attached to the processing line 18, by direct attachment, by an attaching member such as a bracket, and the like. In the illustrative example, each line object tracker L_{X} is connected to the facility network 20 via a PoE cable 62 where feasible, based on the configuration of the processing line 18, such that the line object tracker L_{X} can be powered via the PoE cable 62 and can communicate with the facility network 20 via the PoE cable 62. Where connection of the line object tracker L_{X} via a PoE cable 62 is not feasible, the line object tracker L_{X} can communicate with the facility network 20, for example, via one of the structural object trackers S_{X}, by sending signals and/or data, including digitized action entry 90 data to the structural object tracker S_{X} via the communication modules 80 of the respective line object tracker L_{X} sending the data and the respective structural object tracker S_{X} receiving the data. The data received by the structural object tracker S_{X} from the line object tracker L_{X} can include, in one example, the tracker ID of the line object tracker L_{X} transmitting the data to the receiving structural object tracker S_{X} such that the structural object tracker S_{X} can transmit the tracker ID with the data received from the line object tracker L_{X} to the central data broker 28.

Each mobile object tracker M_{X} is connected to one of the mobile assets 24, such that each mobile object tracker M_{X} is mobile, and is moved through the facility 10 by the mobile asset 24 to which the mobile object tracker M_{X} is connected. Each mobile object tracker M_{X} defines a detection zone 42 which moves with movement of the mobile object tracker M_{X} in the facility 10. In a non-limiting example, the location of each mobile object tracker M_{X} in the facility 10 is determined by the mobile object tracker M_{X} at any time, using, for example, its location module 82 and a SLAM algorithm 70, where the mobile object tracker M_{X} can communicate with other object trackers 24 having a fixed location, to provide input for determining its own location. The example is non-limiting, and other methods can be used. For example, the location module 82 can be configured to determine the GPS coordinates of the mobile object tracker Mₓ to determine location. In the illustrative example, each mobile object tracker M_{X} communicates with the facility network 20, for example, via one of the structural object trackers S_{X}, by sending signals and/or data, including digitized action entry 90 data to the structural object tracker S_{X} via the communication modules 80 of the respective mobile object tracker M_{X} sending the data, and the respective structural object tracker S_{X} receiving the data. The data received by the structural object tracker S_{X} from the mobile object tracker M_{X} can include, in one example, the tracker ID of the mobile object tracker M_{X} transmitting the data to the receiving structural object tracker S_{X} such that the structural object tracker S_{X} can transmit the tracker ID with the data received from the mobile object tracker M_{X} to the central data broker 28. As the mobile object tracker M_{X} identifies mobile assets 24 detected in its detection zone 42, and generates asset entries 90 for each detected mobile asset 24, the mobile object tracker M_{X} transmits the generated asset entries 90 in real time to a structural object tracker S_{X} for retransmission to the central data broker 28 via the facility network 20, such that there is no latency or delay in the transmission of the generated asset entries 90 from the mobile object tracker M_{X} to the central data broker 28. By transmitting all data generated by all of the object trackers 12, including the mobile object trackers M_{X} to the central data broker 28 via a single outlet, the facility network 20, data security is controlled. Each mobile object tracker M_{X} can be powered, for example, by a power source provided by the mobile asset to which the mobile object tracker M_{X} is connected, and/or can be powered, for example, by a portable and/or rechargeable power source such as a battery.

In a non-limiting example, the mobile assets 24 being tracked and analyzed include part carriers C₁ . . . C_{q} and component parts P₁ . . . Pₚ, as shown in FIG. 1. In a non-limiting example, the actions of a mobile asset 24 which are detected and tracked by the object trackers 12 can include movement, e.g., motion, of the mobile asset, including transporting, lifting, and placing a mobile asset 24. In the illustrative example, the actions detected can include removing a component part Pₓ from a part carrier Cₓ, and/or moving a component part Pₓ to a part carrier Cₓ. As used herein, component part Pₓ refers generally to one of the component parts P₁ . . . Pₚ. A component part, as that term is used herein, refers to a component which is used to perform a process within a facility 10. In a non-limiting illustrative example, a component part Pₓ can be configured as one of a workpiece, an assembly including the workpiece, raw material used in forming the workpiece or assembly, a tool, gage, fixture, and/or other component which is used in the process performed within the facility 10. A component part is also referred to herein as a part.

As used herein, a part carrier Cₓ refers generally to one of the part carriers C₁ . . . C_{q}. A part carrier, as that term is used herein, refers to a carrier Cₓ which is used to move a component part Pₓ within the facility 10. In a non-limiting illustrative example, a part carrier Cₓ, can include any mobile asset 24 used to move or action a component part Pₓ, including, for example, containers, bins, pallets, trays, etc., which are configured to contain or support a component part Pₓ during movement or actioning of the component part Pₓ in the facility 10 (see for example carrier C₂ containing part P₁ in FIG. 1). A part carrier Cₓ can be a person 126, such as a machine operator or material handler (see for example carrier C₄ transporting part P₃ in FIG. 1). The part carrier Cₓ, during a detection event, can be empty or can contain at least one component part Pₓ. Referring to FIG. 1, a part carrier Cₓ can be configured as a mobile asset 24 used to transport another part carrier, including, for example, vehicles including lift trucks (see for example C₁, C₃ in FIG. 1), forklifts, pallet jacks, automatically guided vehicles (AGVs), carts, and people. The transported part carrier can be empty, or can contain at least one component part(s) Pₓ (see for example carrier C₁ transporting carrier C₂ containing part P₁ in FIG. 1). A part carrier is also referred to herein as a carrier.

Referring to FIG. 4, shown is a non-limiting example of an object tracker 12 including a tracker computer 60 and at least one sensor 64. The object tracker 12 is enclosed by a tracker enclosure 58, which in a non-limiting example, has an International Protection (IP) rating of IP67, such that the tracker enclosure 58 is resistant to solid particle and dust ingression, and resistant to liquid ingression including during immersion, providing protection from harsh environmental conditions and contaminants to the computer 60 and the sensors 64 encased therein. The tracker enclosure 58 can include an IP67 cable gland for receiving the Ethernet cable 62 into the tracker enclosure 58. The computer 60 is also referred to herein as a tracker computer. The at least one sensor 64 can include a camera 76 for monitoring the detection zone 42 of the object tracker 12, and for generating image data for images detected by the camera 76, including images of asset identifiers 30 detected by the camera 76. In an illustrative example, the asset identifiers 30 detected by the camera 76 can be configured as a bar code or QR code 32, a label or tag 34, a fiducial feature or marking 36, an RFID tag 38, facial data 132, a pattern or shape 136, an asset feature or identifying dimension 140, or a combination of these. The sensors 64 in the object tracker 12 can include an RFID reader 78 for receiving an RFID signal from an asset identifier 30 including an RFID tag 38 detected within the detection zone 42. In one example, the RFID tag 38 is a passive RFID tag. The RFID reader 78 receives tag data from the RFID tag 38 which is inputted to the tracker computer for processing, including identification of the identifier 30 including the RFID tag 38, and identification of the mobile asset 24 associated with the identifier 30. The sensors 64 in the object tracker 12 can include a location module 82, and a communication module 80 for receiving wireless communications including WiFi and Bluetooth® signals, including signals and/or data transmitted wirelessly to the object tracker 12 from another object tracker 12. In one example, the location module 82 can be configured to determine the location of a mobile asset 24 detected within the detection zone 42 of the object tracker 12, using sensor input. The location module 82 can be configured to determine the location of the object tracker 12, for example, when the object tracker 12 is configured as a mobile object tracker Mₓ, using one of the algorithms 70. In one example, the algorithm 70 used by the location module 82 can be a simultaneous localization and mapping (SLAM) algorithm, and can utilize signals sensed from other object trackers 12 including structural object trackers SN having known fixed locations, to determine the location of the mobile object tracker M_{X} at a point in time.

Referring again to FIGS. 1, 5 and 6, shown are non-limiting examples of various types and configurations of identifiers 30 which can be associated with a mobile asset 24 and identified by the object tracker 12 using sensor input received by the object tracker 12. Each mobile asset 24 includes and is identifiable by at least one asset identifier 30. While a mobile asset 24 is not required to include more than one asset identifier 30 to be detected by a objection tracker 12, it can be advantageous for a mobile asset 24 to include more than one identifier 30, such that, in the event of loss or damage to one identifier 30 included in the mobile asset 24, the mobile asset 24 can be detected and tracked using another identifier 30 included in the mobile asset 24.

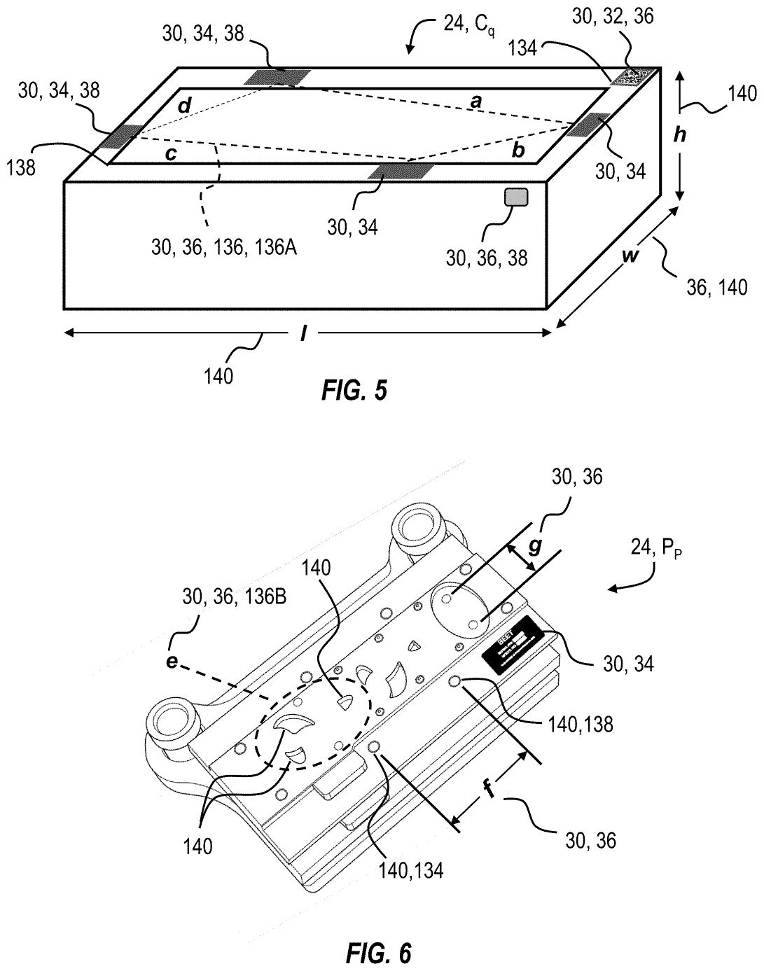

A mobile asset 24, which in the present example is configured as a carrier C_{q} for transporting one or more parts P_{X} is shown in FIG. 5 including, for illustrative purposes, a plurality of asset identifiers 30, including a QR code 32, a plurality of labels 34, a fiducial feature 36 defined by a pattern 136 (the polygon abcd indicated as pattern 136A) formed by the placement of the labels 34 on the carrier C_{q}, the pattern 136 defining a fiducial feature 36, another fiducial feature 36 defined by one or more identifying dimensions 140 of the carrier C_{q}, such as dimensions length l, height h, width w, and an RFID tag 38. Each type 32, 34, 36, 38 of identifier 30 is detectable and identifiable by the object tracker 30 using sensor input received via at least one sensor 64 of the object tracker 30, which can be processed by the tracker computer 60 using one or more algorithms 70. Each identifier 30 included in a mobile asset 24 is configured to provide sensor input and/or identifier data which is unique to the mobile asset 24 to which it is included. The unique identifier 30 is associated with the mobile asset 24 which includes that unique identifier 30 in the database 122, for example, by mapping the identifier data of that unique identifier 30 to the asset instance 104 of the mobile asset 24 which includes that unique identifier 30. For example, the RFID tag 38 attached to the carrier C_{q}, which in a non-limiting example is a passive RFID tag, can be activated by the RFID reader 78 of the object tracker 12 and the unique RFID data from the RFID tag 38 read by the RFID reader 78 when the carrier C_{q} is in the detection zone 42 of the object tracker 12. The carrier C_{q} can then be identified by the tracker computer 60 using the RFID data transmitted from the RFID tag 38 and read by the RFID reader 78, which is inputted by the RFID reader 78 as a sensor input to the tracker computer 60, and processed by the tracker computer 60 using data stored in the database 122 to identify the mobile asset 24, e.g., the carrier C_{q} which is mapped to the RFID data.

In another example, the QR code 32 positioned on the carrier C_{q} can be detected using an image of the carrier C_{q} sensed by the camera 76 of the object tracker 12 and inputted to the tracker computer 60 as a sensor input, such that the tracker computer 60, by processing the image sensor input, can detect the QR code data, which is mapped in the database 122 to the asset instance 104 of the carrier C_{q} and use the QR code data to identify the carrier C_{q}. In another example, the labels 34 can be detected using an image of the carrier C_{q} sensed by the camera 76 of the object tracker 12 and inputted to the tracker computer 60 as a sensor input, such that the tracker computer 60, by processing the image sensor input, can sense each label 34. In one example, at least one of the labels 34 can include a marking, such as a serial number or bar code, uniquely identifying the carrier C_{q} and which is mapped in the database 122 to the asset instance 104 of the carrier C_{q} such that the tracker computer 60 in processing the image sensor input, can identify the marking and use the marking to identify the carrier C_{q}. In another example, the combination of the labels 34 can define an identifier 30 and/or a fiducial feature 36 shown in FIG. 5 as a pattern 136 formed by the placement of the labels 34 on the carrier C_{q}, where, in the present example, the pattern 136A defines a polygon abcd which is unique to the carrier C_{q}, and detectable by the tracker computer 60 during processing of the image sensor input. The identifier 30 defined by the fiducial feature 36, e.g., the unique polygon abcd, is mapped in the database 122 to the asset instance of the carrier C_{q}, such that the tracker computer 60 in processing the image sensor input, can identify and use the polygon abcd to identify the carrier C_{q}. In one example, the identifier 30 can be made of or include a reflective material or a retro-reflective material, for example, to enhance the visibility and/or detectability of the identifier 30 in the image captured by the camera 76, which may be configured to preferentially detect the reflected image and/or the directed light emitted from the retro-reflective material of the label 34. The example of a label 34 is non-limiting, and it would be understood that a reflective or retro-reflective material could be applied to a mobile asset 24 as a paint, decal, label, or by other suitable means.

A mobile asset 24, which in the present example is configured as a part Pₚ is shown in FIG. 5 including, for illustrative purposes, a plurality of asset identifiers 30, including at least one fiducial feature 36 defined by at least one or a combination of part features e, f, g, and a label 34. As described for FIG. 5, the label 34 can include a marking, such as a serial number or bar code, uniquely identifying the part Pₚ and which is mapped in the database 122 to the asset instance 104 of the part Pp such that the tracker computer 60 in processing the image sensor input, can identify the marking and use the marking to identify the part Pₚ. In the example shown in FIG. 6, one or more identifiers 30 and/or fiducial features 36 can be defined by at least one or a combination of part features and dimensions e, f, g, can be formed by the combination of the identifying dimension f and at least one of the hole pattern e and port hole spacing g where the combination of these is unique to the part Pₚ such that the tracker computer 60 in processing the image sensor input, can identify the marking and use the marking to identify the part Pₚ. In one example, the label 34 can be combined with a part dimension or feature 140 to define an identifier 30. In the example shown in FIG. 6, a combination of part features 140 form a pattern 136B to define an identifier 30 which can also be a fiducial feature 36 detectable by the tracker computer 60 during processing of the image sensor input.

Referring to FIG. 1, a mobile asset 24 configured as a carrier C₁ is shown including a mobile object tracker M₁, where in the present example, the mobile object tracker M₁ is an identifier 30 for the carrier C₁, and the tracker ID of the mobile object tracker M₁ associated in the database 122 with the asset instance 104 of the carrier C₁. to which it is attached. When the carrier C₁ including the mobile object tracker M₁ enters a detection zone 42 of another object tracker 12 such as structural object tracker S₁ as shown in FIGS. 1 and 2, the structural object tracker S₁, via its communication module 80 can receive a wireless signal from the mobile object tracker M₁ which can be input from the communication module 80 of the structural object tracker S₁ to the tracker computer 60 of the structural object tracker S₁ as a sensor input, such that the tracker computer 60 in processing the sensor input, can identify the tracker ID of the mobile object tracker M₁ and to identify the mobile object tracker M₁ and the carrier C₁ to which the mobile object tracker M₁ is attached.

Referring again to FIG. 1, a mobile asset 24 identified in FIG. 1 as a carrier C₄ is a person 126, such as a production operator or material handler, shown in the present example transporting a part P₄. The carrier C₄ can include one or more identifiers 30 detectable by the object tracker 12 using sensor input collected by the object tracker 12 and inputted to the tracker computer 60 for processing, where the one or more identifiers 30 are mapped to the carrier C₄ in the database 122. In an illustrative example, the carrier C₄ can wear a piece of clothing, for example, a hat, which includes an identifier 30 such as a label 34 or QR code 32 which is unique to the carrier C₄. In an illustrative example, the carrier C₄ can wear an RFID tag 38, for example, which is attached to the clothing, a wristband, badge or other wearable item worn by the carrier C₄. In an illustrative example, the carrier C₄ can wear or carry an identifier 30 configured to output a wireless signal unique to the carrier C₄, for example, a mobile device such as a mobile phone, smart watch, wireless tracker, etc., which is detectable by the communication module 80 of the object tracker 12.

Referring to FIGS. 11-14, FIG. 11 illustrates an example environment, indicated in the figure as a facility 10, including a plurality of objects 24, also referred to herein as mobile assets 24, which has been manipulated such that one or more object trackers 12 can be used within the facility 10 to track and/or monitor the objects 24. As shown in FIG. 11, the IR light source 72 of the object tracker 12 can be used in conjunction with an identifier 30 including retro-reflective material configured as a standardized shape 136, placed in strategic locations throughout a facility 10 and/or on objects 24, where the retro-reflective material in the standardized shape and/or pattern 136 defines a fiducial feature 36, appearing in the field of view of an object tracker 12 to provide a point of reference, or a measure, relative to the object 24. As shown in FIG. 11, the retro-reflective material can be affixed as a label 34 in a standardized shape or pattern 136, to an asset 24, to provide an asset identifier 30 and fiducial feature 36. The standardized identifier 30 is affixed to and/or positioned on the object 24 in a known position related to the object 24, such that the size, shape 136, orientation, location, and bounded center 134 of the standardized identifier 30 is known relative to the size, shape, orientation, and center of mass 138 of the object 24 to which the standardized identifier is affixed.

In the non-limiting example shown in FIG. 11, asset identifiers 30 are affixed to both mobile assets 24 and non-mobile or fixed assets 24 within a facility 10. Non-limiting examples of assets 24 can include but are not limited to material handling equipment, including mobile material handling equipment such as the forklift 24A shown in FIG. 11, and non-mobile or fixed material handling equipment such as parts conveyors. In the example shown in FIG. 11, retro-reflective material is affixed to the roof of a forklift 24A at a known location and orientation on the forklift 24A and in a standardized pattern 136C (see FIG. 12) to form a standardized object identifier 30 of the forklift 24A. Other objects and/or assets within the facility 10 can be marked with object identifiers 30 which can be standardized for the type of and/or function of the object or asset 24 being marked. In a non-limiting example, retro-reflective material is affixed to a part carrying rack 24B at a known location and orientation on the part carrying rack 24B and in a standardized pattern 136D (see FIG. 12) to form a standardized object identifier 30 of the part carrying rack 24B. In another example, retro-reflective material is affixed to the facility structure, for example, to the floor 24C of the facility 10, in a predetermined location and known size in a standardized pattern 136E (see FIG. 12) to form an object and/or location identifier 30 within the facility 10. Other objects 24 within the facility, for example, equipment, tooling, pallets, hardhats, uniforms, etc. can be marked and/or identified by affixing retro-reflective material in a standardized pattern 136 associated with the object 24 and/or object type, selected from a plurality of standardized patterns 136C, 136D, 136E, 136F, . . . 136n, examples of which are shown in FIG. 12. The reflected light emitted from the retro-reflective material affixed to the object 24 will cause the object 24 including the indicator 30 and standardized pattern 136 to “pop” in the field of view 42 of the object tracker edge device 12, making it easier for the edge computing device 60 to detect, e.g., to pick out, the object 24 from the background and/or other objects 24 in field of view 42, using the image data collected by the image sensor 64 of the object tracker 12.

FIG. 11 illustrates a means to reduce necessary computing power in the edge computer 60 of the edge device 12 by affixing retro-reflective material in a standardized pattern or shape 136 to the objects 24, making it easier to discern and/or separate the objects 24 in the sensed image data from the background in the sensed image. Similarly, FIG. 12 illustrates a means to additionally reduce the computing power used by the edge computing device 60 to classify the objects 24, e.g., to identify an object type and/or object group associated with a detected object 24. In contrast to known methods of using neural networks or some other form of artificial intelligence to classify an object to an object type or object group and require computing power to do so which is too great to complete this type of classification method on a low power edge device, the method and means described herein and illustrated in FIG. 12 are advantaged by substantially reducing the amount of computing power required, such that, by using standardized shapes 136C, 136D . . . 136n of identifiers 30 created with the retro-reflective material applied as illustrated in FIG. 11, the edge computing device 60 has sufficient computing power to very easily classify objects 24 in the field of view 42 of the object tracker edge device 12, using the image data collected by the image sensor 64.

FIG. 13 and FIG. 14 together demonstrate how the mesh network of edge devices 12 can all be trained with standardized shapes 136A . . . 136n of an object identifier 30 and/or face ID data 132 of a subject (person) 126 while only actually interacting with one master edge device 124. In FIG. 13, the far-left (as viewed on the page) imaging device 124, also referred to herein as the master edge device 124, is used to train the system 100, including the other edge devices 12, to detect a standardized shape 136 selected from a plurality of standardized shapes 136A . . . 136n and presented to the master edge device 12. When requested/commanded to train, the master edge device 124 is actuated to sense, using the image sensor S₁, the presented standardized shape 136, which in the example illustrated by FIG. 13 is standardized shape 136C. The master edge device 124 collects, via the edge computer 60 in the master edge device 124, the image data associated with the standardized shape 136C and sends the shape data to the master edge device 124, which sends the data to the rest of the object trackers 12 and/or the server 46, 56. With this method, any edge device 12 can be actuated as and used as a master edge device 124 for shape training of the remaining edge devices 12.

FIG. 14 shows a similar procedure for training the object trackers 12 to detect and/or identify facial keypoints 130 of a subject (person) 126 in the image sensed within the object tracker's field of vision 42. In the illustrative example shown in FIG. 14, the master edge device 124 can be any one of the plurality of edge devices 12. In one example, the training device used to collect an image of the subject (person) 126 can be a training device 128 which in the illustrated example is located in an area having restricted access, such as an office, where the images of the subjects (persons) 126 sensed by the image sensor 64 can be processed by the training device 128, and such that only face keypoints 130 associated with the subject (person) 126 are distributed to and/or accessible by the object tracker edge devices 12. In one example, the face keypoints 130, also referred to as face ID data, for a respective subject (person) 126 may be further restricted such that face keypoints 130 of the respective subject (person) 126 would only be sent to one or more respective object trackers 12 which require the face keypoints 130 of that respective subject (person) 126 to process image data collected by those respective object trackers 12. Restriction of distribution of the face keypoints 130 can be based, for example, on a work assignment of the respective subject (person) 126 and sent to only those object trackers 12 within the facility 10 which are expected to detect the respective subject (person) 126 performing the work assignment.

Referring again to FIG. 14, a method of how the image data of a respective subject (person) 126 is collected and reduced to face keypoints 130 of that respective subject (person) 126 is illustrated. No actual images of the subject (person) 126 are stored, only the encodings, e.g., the face keypoints 130 reduced from the subject's image, are stored to the database and/or to the edge devices 12. By reducing the subject's image to only face keypoints 130, the data (face keypoints 130) which are stored to the database and/or communicated to the edge devices 12 and/or server 46, 56, are filtered down to the point that the actual image of the subject's face cannot be recreated, but the face keypoints 130 that are required by a face identification algorithm included in the system 100 and/or used by the edge computer 60 to identify the subject 126 from image data collected by the edge device 12 are available.

Referring again to FIG. 4, the object tracker 12 includes a tracker computer 60. The object tracker 12 and/or the tracker computer 60 includes a memory 68 for receiving and storing sensor input received from the at least one sensor 64, and for storing and/or transmitting digitized data therefrom including action entry 90 data generated for each detection event. The tracker computer 60 includes a central processing unit (CPU) 66 for executing the algorithms 70, including algorithms for processing the sensor input received from the at least one sensor 64 to detect mobile assets 24 and asset indicators 30 sensed by the at least one sensor 64 within the detection zone 42 of the object tracker 12, and to process and/or digitize the sensor input to identify the detected asset identifier 30 and to generate data to populate an action entry 90 for the detected mobile asset 24 detected in the detection event using the algorithms 70. In a non-limiting example, the algorithms 70 can include algorithms for processing the sensor input, algorithms for time stamping the sensor input with a detection time 92, image processing algorithms including filtering algorithms for filtering image data to identify mobile assets 24 and/or asset identifiers 30 in sensed images, algorithms for detecting asset identifiers 30 from the sensor input, algorithms for identifying an asset ID 86 and asset type 88 associated with an asset identifier 30, algorithms for identifying the location of the detected mobile asset 24 using image data and/or other location input, and algorithms for digitizing and generating an action entry 90 for each detection event. The memory 68, at least some of which is tangible and non-transitory, may include, by way of example, ROM, RAM, EEPROM, etc., of a size and speed sufficient, for example, for executing the algorithms 70, storing the sensor input received by the object tracker 12, and communicating with local network 20 and/or with other object trackers 12. In one example, sensor input received by the tracker computer 60 is stored to the memory 68 only for a period of time sufficient for the tracker computer 60 to process the sensor input, that is, once the tracker computer 60 has processed the sensor input to obtain the digitized detection event data required to populate an action entry 90 for each mobile asset 24 detected from that sensor input, that sensor input is cleared from memory 68, thus reducing the amount of memory required by each object tracker 12.

As shown in FIG. 4, the object tracker 12 includes one or more cameras 76, one or more light emitting diodes (LEDs) 72, and an infrared (IR) pass filter 74, for monitoring and collecting image input from within the detection zone 42 of the object tracker 12. In a non-limiting example, the object tracker 12 includes a camera 76 which is an infrared (IR) sensitive camera, and the LEDs 72 are infrared LEDs, such that the camera 76 is configured to receive image input using visible light and infrared light. In a non-limiting example, the object tracker 12 can include an IR camera 76 configured as a thermal imaging camera, for sensing and collecting heat and/or radiation image input. It would be appreciated that the one or more cameras 76 included in the object tracker 12 can be configured such that the object tracker 12 can monitor its detection zone 42 for a broad spectrum of lighting conditions, including visible light, infrared light, thermal radiation, low light, or near blackout conditions. In a non-limiting example, the object tracker 12 includes a camera 76 which is a high resolution and/or high definition camera, for example, for capturing images of an identifier 30, such as fiducial features and identifying dimensions of a component part P_{X}, identifying numbers and/or marks on a mobile asset 24 and/or identifier 30 including identifying numbers and/or marks on labels and tags, etc. As such, the object tracker 12 is advantaged as capable of and effective for monitoring, detecting and tracking mobile assets 24 in all types of facility conditions, including, for example, low or minimal light conditions as can occur in automated operations, in warehouse or storage locations including exterior structures 16 which may be unlit or minimally lighted, etc. The camera 76 is in communication with the tracker computer 60 such that the camera 76 can transmit sensor input, e.g., image input, to the tracker computer 60 for processing by the tracker computer 60 using algorithms 70. In one example, the object tracker 12 can be configured such that the camera 76 continuously collects and transmits image input to the tracker computer 60 for processing. In one example, the object tracker 12 can be configured such that the camera 76 initiates image collection periodically, at a predetermined frequency controlled, for example, by the tracker computer 60. In one example, the collection frequency can be adjustable or variable based on operating conditions within the facility 10, such as shut down conditions, etc. In one example, the object tracker 12 can be configured such that the camera 76 initiates image collection only upon sensing a change in the monitored images detected by the camera 76 in the detection zone 42. In another example, the camera 76 can be configured and/or the image input can be filtered to detect images within a predetermined area of the detection zone 42. For example, where the detection zone 42 overlaps an area of the facility 42, such as an office area, where mobile assets 24 are not expected to be present, a filtering algorithm can be applied to remove image input received from the area of the detection zone 42 where mobile assets 24 are not expected to be present. Referring to FIG. 1, the camera 76 can be configured to optimize imaging data within a predetermined area of the detection zone 42, such as an area extending from the floor of the structural enclosure 14 to a vertical height corresponding to the maximum height at which a mobile asset 42 is expected to be present.

The tracker computer 60 receives sensor input from the various sensors 64 in the object tracker 12, which includes image input from the one or more cameras 76, and can include one or more of RFID tag data input from the RFID reader 78, location data input from the location module 82, and wireless data from the communication module 80. The sensor input is time stamped by the tracker computer 60, using a live time obtained from the facility network 20 or a live time obtained from the processor 66, where in the later example, the processor time has been synchronized with the live time of the facility network 20. The facility network 20 time can be established, for example, by the central data broker 28 or by a server such as local server 56 in communication with the facility network 20. Each of the processors 66 of the object trackers 12 is synchronized with the facility network 20 for accuracy in time stamping of the sensor input and accuracy in determining the detected time 92 of a detected mobile asset 24.

The sensor input is processed by the tracker computer 60, using one or more of the algorithms 70, to determine if the sensor input has detected any identifiers 30 of mobile assets 24 in the detection zone 42 of the object tracker 12, where detection of an identifier 30 in the detection zone 42 is a detection event. When one or more identifier 30 is detected, each identifier 30 is processed by the tracker computer 60 to identify the mobile asset 24 associated with the identifier 30, by determining the asset instance 104 mapped to the identifier 30 in the database 122, where the asset instance 104 of the mobile asset 24 associated with the identifier 30 includes the asset ID 86 and the asset type 88 of the identified mobile asset 24. The asset ID 86 is stored in the database 122 as a simple unique integer mapped to the mobile asset 24, such that the tracker computer 60, using the identifier 30 data, retrieves the asset ID 86 mapped to the detected mobile asset 24, for entry into an action entry 90 being populated by the tracker computer 60 for that detection event. A listing of types of assets is stored in the database 122, with each asset type 88 mapped to an integer in the database 122. The tracker computer 60 retrieves the integer mapped to the asset type 88 associated with the asset ID in the database 122, for entry into the action entry 90. The database 122, in one example, can be stored in a server 46, 56 in communication with the central data broker 28 and the analyst 54, such that the stored data is accessible by the central data broker 28, by the analyst 54, and/or by the object tracker 12 via the central data broker 28. The server can include one or more of a local server 56 and a remote server 46 such as a cloud server accessible via a network 48. The example is non-limiting, and it would be appreciated that the database 122 could be stored in the central data broker 28, or in the analyst 54, for example. In an illustrative example, an asset type can be a category of an asset, such as a part carrier or component part, can be a specific asset type, such as a bin, pallet, tray, fastener, assembly, etc., or a combination of these, for example, a carrier-bin, carrier-pallet, part-fastener, part-assembly, etc. Non-limiting examples of various types and configurations of identifiers 30 which may be associated with a mobile asset 24 are shown in FIGS. 5 and 6 and are described in additional detail herein.

The tracker computer 60 populates an action entry 90 data structure (see FIG. 7) for each detection event, entering the asset ID 86 and the asset type 88 determined from the identifier 30 of the mobile asset 24 detected during the detection event into the corresponding data fields in the action entry 90, and entering the timestamp of the sensor input as the detection time 92. The tracker computer 60 processes the sensor input to determine the remaining data elements in the action entry 90 data structure, including the action type 94. By way of example, action types 94 that can be tracked can include one or more of locating a mobile asset 24, identifying a mobile asset 24, tracking movement of a mobile asset 24 from one location to another location; lifting a mobile asset 24 such as lifting a carrier C_{X} or a part P_{X}, placing a mobile asset 24 such as placing a carrier C_{X} or a part P_{X} onto a production line 18; removing a mobile asset 24 from another mobile asset 24 such as unloading a carrier C_{X} (pallet, for example) from another carrier C_{X} (lift truck, for example) or removing a part P_{X} from a carrier C_{X}, placing a carrier C_{X} onto another carrier C_{X}, placing a part P_{X} to a carrier C_{X}, counting the parts P_{X} in a carrier C_{X}, etc., where the examples listed are illustrative and non-limiting. The tracker computer 60 processes the sensor input and determines the type of action being tracked from the sensor input, and populates the action entry 90 with the action type 94 being actioned by the detected asset 24 during the detection event. A listing of types of actions is stored in the database 122, with each action type 94 mapped to an integer in the database 122. The tracker computer 60 retrieves an integer which has been mapped to the action type 94 being actioned by the detected asset 24, for entry into the corresponding action type field in the action entry 90.

The tracker computer 60 processes the sensor input to determine the location 96 of the mobile asset 24 detected during the detection event, for entry into the corresponding field(s) in the action entry 90. In the illustrative example shown in FIG. 7, the data structure of the action entry 90 can include a first field for entry of an x-location and a second field for entry of a y-location, where the x- and y-locations can be x- and y-coordinates, for example, of the location of the detected mobile asset 24 in an X-Y plane as defined by the XYZ reference axes and reference point 26 defined for the facility 10. The tracker computer 60 can, in one example, use the location of the object tracker 12 at the time of the detection event, in combination with the sensor input, to determine the location 96 of the detected mobile asset 24. For a structural object tracker S_{X} and for a line object tracker L_{X}, the location of the object tracker 12 is known from the fixed position of the object tracker S_{X}, Lx in the facility 10. For an object tracker 12 configured as a mobile object tracker M_{X}, the tracker computer 60 and/or the location module 82 included in the mobile object tracker M_{X} can determine the location of the mobile object tracker M_{X} using, for example, a SLAM algorithm 70 and signals sensed from other object trackers 12 including structural object trackers S₁ SN having known fixed locations, to determine the location of the mobile object tracker M_{X} at the time of the detection event, which can then be used by the tracker computer 60 in combination with the sensor input to determine the location 96 of the detected mobile asset 24, for input into the corresponding location field(s) in the action entry 90. The example of entering an X-Location 96 and a Y-Location 96 into the action entry 90 is non-limiting, for example, other indicators of location could be entered into the action entry 90 such as GPS coordinates, a Z Location in addition to the X and Y locations, etc.

In one example, the sensor input can be used by the tracker computer 60 to determine one or more interactions 98 of the detected asset 24. The type and form of the data entry into the interaction field 98 of the action entry 90 is dependent on the type of interaction which is determined for the mobile asset 24 detected during the detection event. For example, where the detected asset 24 is a second part carrier C₂ being conveyed by another mobile asset 24 which is a first part carrier C₁, as shown in FIG. 1, an interaction 98 determined by the tracker computer 60 can be the asset ID 86 and the asset type 88 of the first part carrier C₁ being used to convey the detected asset 24, e.g., the second part carrier C₂. Using the same example shown in FIG. 1, the second part carrier C₂ is a container carrying a component part Pi, such that other interactions 98 which can be determined by the tracker computer 60 can include, for example, one or more of a quantification of the number, type, and/or condition of part PI being contained in the second part carrier C₂, where the part condition, for example as shown in FIG. 6, can include a part parameter such as a dimension f, g, a feature 140, a group of features defining a pattern 136B, or other parameter (see FIG. 6) determinable by the object tracker 60 from the image sensor input. In one example, the part parameter and/or a combination of part parameters can define an identifier 30 and/or a fiducial feature 36, as shown in FIG. 6. In one example, the part parameter can be compared by the object tracker 60 and/or the analyst 54, to a parameter specification, to determine whether the part condition conformance to the specification. The part parameter, for example, a dimension, can be stored as an interaction 98 associated, in the present example, with the part P₁, to provide a digitized record of the condition of the parameter. In the event of a nonconformance of the part condition to the specification, the system 100 can be configured to output an alert, for example, indicating the nonconformance of the part P₁ so that appropriate action (containment, correction, etc.) can be taken. Advantageously, the detection of the nonconformance occurs in this example while the part P₁ is within the facility, such that the nonconforming part P₁ can be contained and/or corrected prior to subsequent processing and/or shipment from the facility 10. Subsequent tracking of the second part carrier C₂ and its interactions can include detection of unloading of the second part carrier C₁ from the first part carrier C₁, unloading of the component part P₁ from the second part carrier C₂, movement of the unloaded component part P₁ to another location in the facility 10, such as to a production line L₁, and so on, where each of these actions is detected by at least one of the object trackers 12, and generates, via the object tracker 12, an action entry 90 associated with at least one of the carriers C₁, C₂ and part P₁, each of which is a detected asset 24, and/or an interaction 98 between at least two more of the carriers C₁, C₂ and part P₁. In one example, the action entries 90 of the sequenced actions of the detected assets 24, including carriers C₁, C₂ and part P₁, and the action entries 90 transmitted to the central data broker 28 during detection of these assets, can analyzed by the analyst 54 using the detection time data T, location data 96 and interaction data 98 from the various action entries 90 and/or action list data structures 102 associated with each of the carriers C₁, C₂ and part P₁, to generate block chain traceability of the carriers C₁, C₂ and part Pi based on their movements as detected by the various object trackers 12 during processing in the facility 10.

In one example, the tracker computer 60 can be instructed to enter a defined interaction 98 based on one or a combination of one or more of the asset ID 86, asset type 88, action type 94, and location 96. In an illustrative example, referring to FIGS. 1 and 6, when the line object tracker L_{K} detects part Pₚ (see FIG. 6) moving on an infeed conveyor processing by the processing line 18, the tracker computer 60 of the line object tracker L_{K} is instructed to process the image sensor input to inspect at least one parameter of the part Pₚ, for example, to measure dimension “g” shown in FIG. 6 and to determine whether the port hole pattern indicated at “e” shown in FIG. 6 conforms to a specified pattern, prompting the tracker computer 60 to enter into the interaction 98 field the inspection result, for example, the measurement of dimension “g” and a “Y” or “N” determination of conformance of the hole pattern of part Pₚ to the specified hole pattern. In one example, interaction 98 data entered into action entries 90 generated as the part Pₚ is processed by process lines 18 and/or moves through the facility 10, and can provide block chain traceability of the part Pₚ, determined from the action list 102 data structure for the asset, in this example, part Pₚ. In a non-limiting example, the line object tracker L_{K} can be instructed, on finding the pattern to be non-conforming to the specified hole pattern, to output an alert, for example, to the processing line 18, to correct and/or to contain the nonconforming part Pₚ prior to further processing.

After the tracker computer 60 has populated the data fields 86, 88, 90, 92, 94, 96, 98 of the action entry 90 for the detected event, the action entry 90 is digitized by the tracker computer 60 and transmitted to the central data broker 28 via the facility network 20. In an illustrative example, the action entry 90 is generated in JavaScript Object Notation (JSON) by serializing the data populating the data fields 86, 88, 90, 92, 94, 96, 98 into a JSON string for transmission as an action entry 90 for the detected event. As shown in FIGS. 7 and 8, the central data broker 28 deserializes the action entry 90 data, and maps the action entry 90 data for the detected asset 24 to an action list 102 data structure for the detected asset 24, for example, using the asset instance 104, e.g., the asset ID 86 and asset type 88 of the detected asset 24. The data from the data fields 90, 92, 94, 96, 98 of the action entry 90 for the detected event is mapped to the corresponding data fields in the action list 102 as an action added to the listed action entries 90A, 90B, 90C . . . 90n in the action list 102. The action list 102 is stored to the database 122 for analysis by the data analyst 54. The action list 102 can include an asset descriptor 84 for the asset 24 identified by the asset instance 104.

Over time, additional actions are detected by one or more of the object trackers 12 as the asset 24 is used in performing a process within the facility 10, and additional action entries 90 are generated by the object trackers 12 detecting the additional actions, and are added to the action list 102 of the mobile asset 24. For example, referring to FIG. 2, an action event 40 is shown wherein a mobile asset 24, shown in FIG. 2 as carrier C₁, is requested to retrieve a second mobile asset 24 shown in FIG. 1 as a pallet carrier C₂, and to transport the pallet carrier C₂ from a retrieval location indicated at in FIG. 2, to a destination location indicated at C₁ in FIG. 2, where the delivery location corresponds to the location of the carrier C₁ shown in FIG. 1. The action event 40 of the carrier C₁ delivering the pallet carrier C₂ from the retrieval location to the destination location is illustrated by the path shown in FIG. 2 as a bold broken line indicated at 40. During execution of the action event 40, the carrier C₁ and the pallet carrier C₂ move through numerous detection zones 42, as shown in FIG. 2, including the detection zones defined by structural object trackers S₁, S₃, S₅, and S₇ and the detection zone defined by line object tracker S₁, S₃, S₅, and S₇ where each of these object trackers 12 generates and transmits one or more action entries 90 for each of the carriers C₁, C₂ to the central data broker 28 as the action event 40 is completed by the carrier C₁. In addition, during the action 40, the mobile object tracker M₁ attached to the carrier C₁ is generating and transmitting one or more action entries 90 for each of the carriers C₁, C₂. As previously described, the central data broker 28, upon receiving each of the action entries 90 generated by the various object trackers S₁, S₃, S₅, S₇, L₁ and M₁, deserializes the action entry data from each of the action entries and inputs the deserialized action entry data into the asset action list 102 corresponding to the action entry 90, and stores the asset action list 102 to the database 122.

Using the example of the asset action list 102 generated for the pallet carrier C₂, the data analyst 54 analyzes the asset action list 102, including the various action entries 90 generated for actions of the pallet carrier C₂ detected by the various object trackers 12 as the pallet carrier C₂ was transported by the carrier C₁ from the retrieval location to the destination location during the action event 40. The analysis of the asset action list 102 and the action entries 90 contained therein performed by the analyst 54 can include using one or more algorithms to, for example, reconcile the various action entries 90 generated by the various object trackers S₁, S₃, S₅, S₇, L₁ and M₁ during the action event 40, for example, to determine the actual path taken by the pallet carrier C₂ during the action event 40 using for example, the action type 94 data, the location 96 data and time stamp 92 data from the various action entries 90 in the asset action list 102, to determine an actual action event duration 108 for the action event 40 using, for example, the action event durations 108 and time stamp 92 data from the various action entries 90 in the asset action list 102, to generate a tracking map 116 showing the actual path of pallet carrier C₂ during the action event 40, to generate a heartbeat 110 of the mobile asset 24, in this example, pallet carrier C₂, to compare the actual action event 40 for example, to a baseline action event 40, to statistically quantify the action event 40, for example, to provide comparative statistical regarding the action event duration 108, etc. The analyst 54 can associate and store in the database 122 the action event 40 with asset instance 104 of the mobile asset 24, in this example the pallet carrier C₂, with the tracking map data (including path data identifying the path traveled by the pallet carrier C₂ during the action event 40), and with the action event duration 108 determined for the action event 40 and stored to the database 122. In an illustrative example, the action event 40 can be associated with one or more groups of action events having a common characteristic, for comparative analysis, where the common characteristic shared by the action events associated in the group like action, can be, for example, the event type, the action type, the mobile asset type, the interaction, etc.

The tracking map 116 and the mobile asset heartbeat 110 are non-limiting examples of a plurality of visualization outputs which can be generated by the analyst 54, which can be stored to the database 122 and displayed, for example, via a user device 50 or output display 52. In one example, the visualization outputs, including the tracking map 116 and mobile asset heartbeat 116 can be generated by the analyst 54 in near real time such that these visualization outputs can be used to provide alerts, show action event status, etc. to facilitate identification and implementation of corrective and/or improvement actions in real time. As used herein, an “action event” is distinguished from an “action”, in that an action event 40 includes, for example, the cumulative actions executed to complete the action event 40. In the present example, the action event 40 is the delivery of the pallet carrier C₂ from the retrieval location (shown at C′₁ in FIG. 2), to the destination location (indicated at C₁ in FIG. 2), where the action event 40 is a compilation of multiple actions detected by the object trackers S₁, S₃, S₅, S₇, L₁ and M₁ during completion of the action event 40, including, for example, each action of the pallet carrier C₂ detected by the object tracker S₁ in the detection zone 42 of the object tracker S₁ for which the object tracker S₁ generated an action entry 90, each action of the pallet carrier C₂ detected by the object tracker S₂ in the detection zone 42 of the object tracker S₂ for which the object tracker S₂ generated an action entry 90, and so on. As used herein, the term “baseline” as applied, for example, to an action event duration 108, can refer to one or more of a design intent duration for that action event 40, a statistically derived value, such as a mean or average duration for that action event 40 derived from data collected of like action events 40.

The tracking map 116 can include additional information, such as the actual time at which the pallet carrier C₂ is located at various points along the actual delivery path shown for the action event 40, the actual event duration 108 for the action event 40, etc., and can be color coded or otherwise indicate comparative information. For example, the tracking map 116 can display a baseline action event 40 with the actual event 40, to visual deviations of the actual action event 40 from the baseline event 40. For example, an action event 40 with an actual event duration 108 which is greater than a baseline event duration 108 for that action event can be coded red to indicate an alert or improvement opportunity. An action event 40 with an actual event duration 108 which is less than a baseline event duration 108 for that action event can be coded blue and investigate reasons for the demonstrated improvement, for replication in future action events of that type. The tracking map 116 can include icons identifying the action type 94 of the action event 40 shown on the tracking map 116, for example, whether the action event 40 is a transport, lifting, or placement type action. In one example, each action event 40 displayed on the tracking map 116 can be linked, for example, via a user interface element (UIE) to detail information for that action event 40 including, for example, the actual event duration 108, a baseline event duration, event interactions, a comparison of the actual event 40 to a baseline event, etc.

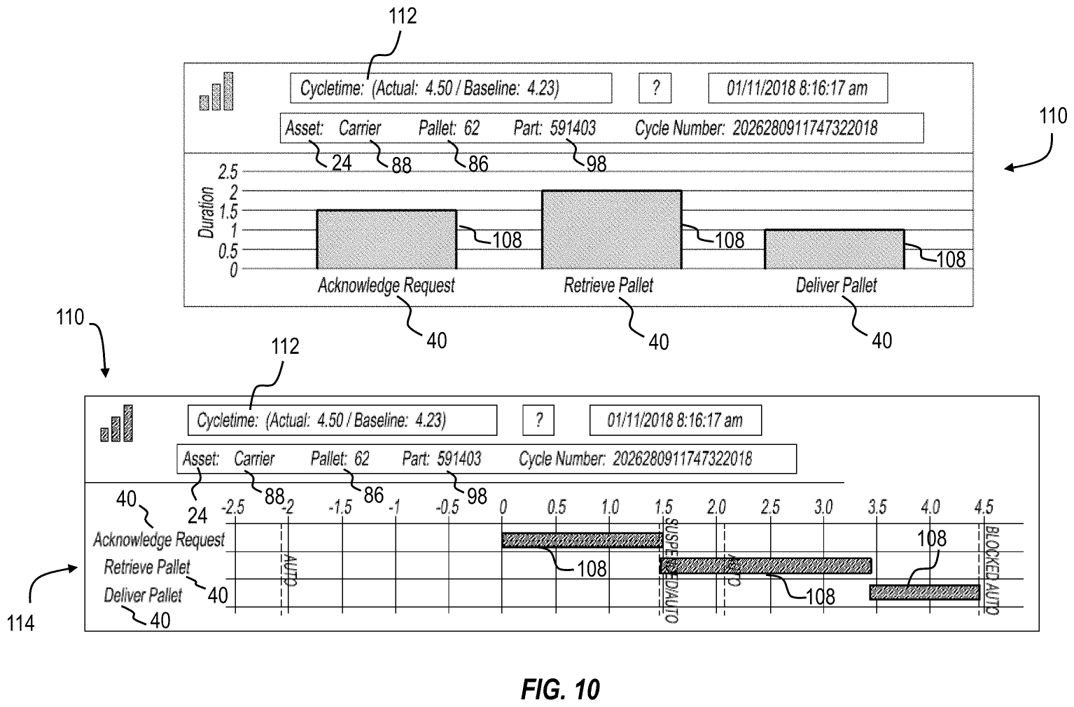

FIG. 10 illustrates an example of a heartbeat 110 generated by the analyst 54 for a sequence of action events 114 performed by a mobile asset 24, which in the present example is the pallet carrier C₂ identified in the heartbeat 110 as having an asset type 88 of “carrier”, and an asset ID of 62. The sequence of action events 114 include action events 40 shown as “Acknowledge Request”, “Retrieve Pallet,” and “Deliver Pallet”, where the action event 40 “Deliver Pallet” in the present example is the delivery of the pallet carrier C₂ from the retrieval location (shown at C in FIG. 2), to the destination location (indicated at C₁ in FIG. 2). The action event duration 108 is displayed for each of the action events 40. An interaction 98 for the sequence of action events 114 is displayed, where a part identification is shown, corresponding in the present example to the part P₁ transported in the pallet carrier C₂. A cycle time 112 is shown for the sequence of action events 114, including the actual cycle time 112 and a baseline cycle time. The heartbeat 110 is generated for the sequence of action events 114 as described in U.S. Pat. No. 8,880,442 B2 issued Nov. 4, 2014 entitled “Method for Generating a Machine Heartbeat”, by ordering the action event durations 108 of the action events 40 comprising the sequence of action events 114. The heartbeat 110 can be displayed as shown in the upper portion of FIG. 10, as a bar chart, or, as shown in the lower portion of FIG. 10, including the sequence of action events 114. Each of the displayed elements, for example, the action event durations 108, the cycle time 112, etc., can be color coded or otherwise visually differentiated to convey additional information for visualization analysis. In one example, each of the action event durations 108 may be colored “red”, “yellow”, “green”, or “blue” to indicate whether the action event duration 108 is, respectively, above an alert level duration, greater than a baseline duration, equal to or less than a baseline duration, or substantially less than a baseline duration indicating an improvement opportunity. In one example, one or more of the elements displayed by the heartbeat 110, including for example, the action event 40, the action event duration 108, the interaction 98, the sequence cycle time 112, the sequence of action events 114, can be linked, for example, via a user interface element (UIE) to detail information for that element. For example, the action event duration 108 can be linked to the tracking map 116, to show the action 40 corresponding to the action event duration 108.

In one example, the sequence of action events 114 can be comprised of action events 40 which are known action events 40, and can, for example, be included in a sequence of operations executed to perform a process within the facility 10, such that, by tracking and digitizing the actions of the mobile assets 24 in the facility 10, the total cycle time required to perform the sequence of operations of the process can be accurately quantified and analyzed for improvement opportunities, including reduction in the action event durations 108 of the action events 40. In one example, not all of the actions tracked by the object trackers 12 will be defined by a known action event 40. In this example, advantageously, the analyst 54 can analyze the action entry 90 data, for example, to identify patterns in actions of the mobile assets 12 within the facility 10, including patterns which define repetitively occurring action events 40, such that these can be analyzed, quantified, baselined, and systematically monitored for improvement.

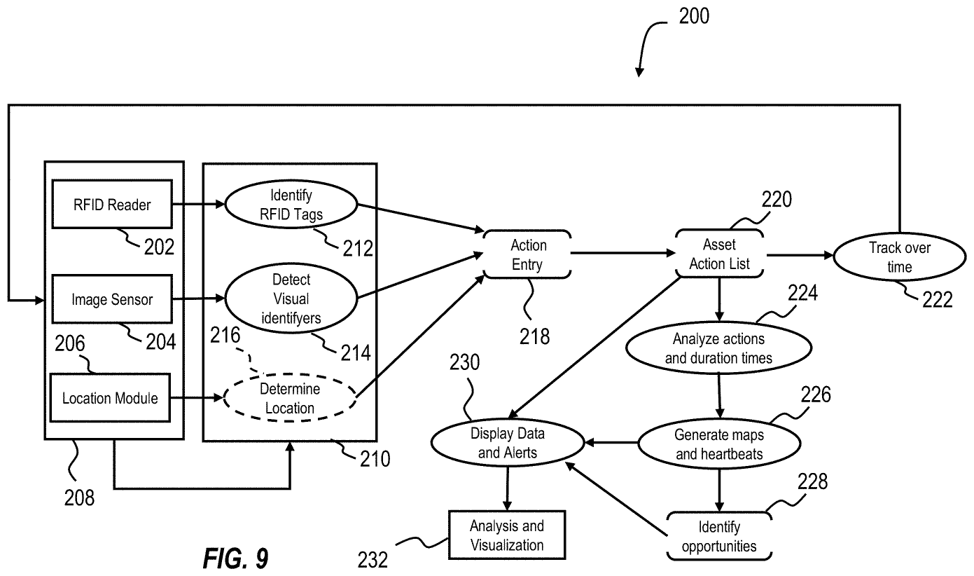

Referring now to FIG. 9, a method for tracking actions of the mobile assets 24 used to perform a process within the facility 10 is shown. The method includes, at 208, the object tracker 24 monitoring and collecting sensor input from within the detection zone 42 defined by the object tracker. The sensor input can include, as indicated at 202, RFID data received from an identifier 30 including an RFID tag 38, image sensor input, as indicated at 204, collected using a camera 72, which can be an IR sensitive camera, and location data, indicated at 206, collected using a location module 82. Location data can also be collected, for example, via a communication module 80, as described previously herein. At 210, the sensor input is received by the object tracker 12 and time stamped, as previously described herein, and the object tracker 12 processes the sensor input data, to at least one identifier 30 for each mobile asset 24 located within the detection zone 42, using, for example, one or more algorithms, to identify, at 212, an RFID identifier 38, at 214, a visual identifier 30 which can include one or more of a bar code identifier 32, a label identifier 34, and at 216, a fiducial identifier 36. At 218, the object tracker 12, using the identifier data determined at 210, populates an action entry 90 for each detection event found in the sensor input, digitizes the action entry 90, for example, into a JSON string, and transmits the digitized action entry 90 to a central data broker 28. At 220, the central data broker 28 deserializes the action entry 90, and maps the action entry 90 to an asset action list 102 corresponding to the detected asset 24 identified in the action entry 90, where the mapped action entry 90 data is entered into the asset action list 102 as an action entry 90, which can be one of a plurality of action entries 90 stored to that asset action list 102 for that detected mobile asset 24. Continuing at 220, the central data broker 28 stores the asset action list 102 to a database 122. At 222, the process of the object tracker 12 monitoring and collecting sensor input from its detection zone 42 continues, as shown in FIG. 9, to generate additional action entries 90 corresponding to additional identifiers 30 detected by the object tracker 12 in its detection zone 42. At 224, a data analyst 54 accesses the asset action list 102 in the database 122, and analyzes the asset action list 102 as described previously herein, including, at 224, determining and analyzing action event durations 108 for each action event 40 identified by the analyst 54 using the asset action list 102 data. At 226, the analyst 54 generates one or more visualization outputs such as tracking maps 116 and/or action event heartbeats 110. At 228, the analyst 54 identifies opportunities for corrective actions and/or improvements using the asset action list 102 data, which can include, at 230 and 232, displaying the data and alerts and displaying one or more visualization outputs such as the tracking maps 116 and/or action event heartbeats 110, output alerts, etc., generated at 226, for use in reviewing, interpreting, and analyzing the data to determine corrective actions and improvement opportunities, as previously described herein.

Referring now to FIG. 15, a method is illustrated for using known data of a standardized shape 136 defining an identifier 30 of an object 24, to determine the pose of the given shape 136, the identifier 30 including the shape 136, and/or the object 24 to which the shape 136 is affixed. Referring to FIG. 15, shown is an example object 24 including an identifier 30 having a standardized shape 136F, where the identifier 30 is affixed to the object 24 in a known position and orientation relative to the object 24. In the example shown, the identifier 30 is made of a retro-reflective material such that the identifier 30 is highly detectable by an object tracker 12. The method for determining the pose of the shape 136 and therefore the pose of the object 24 to which it is affixed, includes identifying a first reference point 134 defined by the standardized shape 136, which in the example shown in FIG. 15 is a center of a bounding box [x,y] containing the standardized shape 136F, the center of the bounding box also referred to herein as the bounded center. The method includes identifying a second reference point 138 defined by the standardized shape 136F, which in the example shown is the center of mass of the standardized shape 136F, which can also be referred to as the geometric center of the standardized shape 136F. The actual (physical) positional relationship between the first and second reference points 134, 138 is known for the standardized shape 136F, for example, recorded to the database 28 and accessible by the object tracker 12. In the present example, the actual positional relationship between the first and second reference points 134, 138 includes the physical location of the points 134, 138 along the longer segment of the “T” shape 136F and the actual (measured) linear distance between the reference points 134, 138. The actual positional relationship can be referred to herein as the known positional relationship, and the actual (measured) distance between the reference points can be referred to herein as the known distance. The method includes receiving sensor input to an object tracker 12 at a detection time, the sensor input including an image of the object 24 including the identifier 30 and standardized shape 136F, and processing the sensor input and image to determine the location of the first reference point 134 as shown in the image, referred to herein as the image location of the first reference point 134, to determine the location of the second reference point 138 shown in the image, referred to herein as the image location of the second reference point 138, and to determine the image positional relationship between the first and second reference points 134, 138 as shown in the image, referred to herein as the image positional relationship of the points 134, 138, which in the present example includes the linear distance between the reference points 134, 138 determined from the image. The method includes comparing the known positional relationship to the image positional relationship, for example, by comparing the known distance between the reference points 134, 138 to the image linear distance between the points 134, 138 as determined from the image, to determine which direction [θ] the standardized shape 136 is facing at the detection time of the image, and thereby determining the direction the object 24 to which the standardized shape 136F is affixed is facing, by knowing the fixed orientation of the standardized shape 136 relative to the object 24.

In the example shown in FIG. 15, the method of determining the pose of the object 24 includes comparing the location of the bounded center 134 of the bounding box [x,y] relative to the location of the center of mass 138 as determined from the image of the standardized shape 136F, to the actual location of the bounded center 134 of the bounding box [x,y] relative to the actual location of the center of mass 138, to determine which direction [θ] the standardized shape 136F is facing, and thereby determining the facing direction θ of the object 24 to which the standardized shape 136F is affixed, by knowing the fixed orientation of the standardized shape 136F relative to the object 24. See, for example, FIG. 17 showing a fixed orientation of the standardized shape 136C relative to the roof and front portion of the forklift 24A. See, for example, FIGS. 11 and 17 showing a fixed orientation of the standardized shape 136D relative to the upper rim of the parts carrier (bin) 24B. The actual location of the reference points 134, 138 can be referred to herein as the known location of the reference points 134, 138. The known location of the reference points 134, 138 for a respective identifier 30, and the known positional relationship between the reference points 134, 138 for the respective identifier 30 can be associated with the respective identifier 30, in the database 28. The direction [θ] can be expressed as an angle relative to a fixed datum established within the facility 10 and/or relative to the object 24. In one example, the direction [θ] can be expressed relative to a datum established by one or more location identifiers 30 indicated in the facility 10 by stationary (non-mobile) standardized shapes such as the standardized shape 136E shown in FIG. 11 affixed to a stationary object 24C within the facility 10. Since the standardized shape 136 is positioned on the object 24 in a known position and/or orientation, once the direction [θ] the identifier 30 including the standardized shape 136 is facing is known by determining the bounded center 134 of the identifier 30 attached to the object 24, a front edge of the object 24 can be determined. Using the image width [s] of the front edge, e.g., the width [s] of the front edge of the object 24 in the image sensed by the object tracker 12 at the detection time of the image, compared to the actual (known) width of the object 24, the distance of the object 24 from the object tracker 12, e.g., the location of the object 24, can be determined. By comparing the observed image width [s] to the known object width, the scale of the object in the image, e.g., in the field of view 42 can be determined. From this, the distance that the object 24 is located from the image sensor 64 of the object tracker 12 detecting the object 24 can be determined, hence determining the location of the object 24 in the facility 10 relative to the known location of the object tracker 12. The example is non-limiting, such that the method can use the observed width [s] of the front edge, e.g., the image width of the front edge of the standardized shape 36 in the image sensed by the object tracker 12, compared to the known (actual) width of the standardized shape 36, to determine the location of the standardized shape 36, and hence, the location of the object 24 to which it is affixed. By comparing the observed width [s] to the known width, the scale of the standardized shape 36 detected in the image, e.g., in the field of view 42 of the object tracker 12, can be determined.

FIG. 16 demonstrates how the four features [x, y, s, θ] described in FIG. 15 of an object 24 with an affixed identifier 30 including a standardized shape 136, can be used by the plurality of object trackers 12, via image data collected by the image sensors 64 and processed by the edge computers 60 of the plurality of object trackers 12, to determine the position, location, and facing direction of the object 24 relative to the plurality of object trackers 12, for example, during movement of the object 24 through the facility 10. When the image sensors 64 of two or more of the object trackers 12 detect the same object 24 in their respective field of view 42, each of the object trackers 12 detecting the object 24 senses and determines the four features [x, y, s, θ] which are sent to the master device 12M and/or server 46, 56. The field of view 42 can also be referred to herein as a detection zone 42 of a respective object tracker 12. The data set [x, y, s, θ] transmitted by the object tracker 12 can be time stamped with a detected time 92 by at least one of the image sensor 64, edge computing device 60, object tracker 12, and/or server 46, 56, to indicate the actual time at which the image sensor 64 sensed the object 24 to generate the four features [y, s, θ]. The edge computer 60 uses one or more algorithms to identify an asset type and asset ID of the sensed object 24, using for example, the identifier 30 and/or standardized shape 136. A master edge device 124 and/or server 46, 56 compares the values [x, y, s, θ] received from the two or more object trackers 12 for the sensed object 24 and returns the relative position and location 96 of the sensed object 24 as the sensed (known) object 24 travels through the facility 10 along an action path 40. As the object 24 travels along the action path 40 through multiple detection zones 42, each object tracker 12 generates and time stamps a data set [x, y, s, θ] at each detection time 92 when that object tracker 12 detects the object 24 within its respective detection zone 42. For each detection event, e.g., at each detected time 92 along the action path 40 for which the data set [x, y, s, θ] is generated by a respective one of the object trackers 12, an action entry 90 is generated by the respective object tracker 12 and saved to the database, each action entry 90 including the asset ID and asset type of the sensed object 24, the detected time 92, the data set [x, y, s, θ] associated with the detected time 92, and the position and location 96 of the object 24 in the facility 10. At each detected time 92, the master edge device 124 and/or server 46, 56 compares the position and location 96 of the object 24 to the relative positions of neighboring objects 24 and associates the detected interactions with the neighboring objects 24 in the action entry 90 for the detected time 92.

The example shown in FIGS. 15 and 16 is illustrative of determining the pose and location of an object 24 including an indicator 30 having a standardized shape 136. The example of first and second references 134, 138 determined respectively as the bounded center and center of mass of a standardized shape is non-limiting, and other combinations of references 134, 138 can be used in the method as described. For example, the method of determining the pose, facing direction θ, and location of an object 24 can include a first reference point 134 defined by an identifier 30 and a second reference point 138 defined by the object 24, referring to FIG. 5, where the first reference point 134 is defined by the interior corner of the bar code label 32, which is also an identifier 30, and where the second reference point 138 is defined by the interior corner of the opening in the container Cq, shown as the object 24. After determining the direction of the container Cq using the first and second reference points 134, 138, the actual (known) width w of the container Cq can be compared to the image width of the container Cq to determine the distance of the container Cq from the object tracker 12 and therefore the pose and location of the container Cq in the facility, using the method as previously described herein. In another example, referring to FIG. 6, the first and second reference points 134, 138 are defined by the object 24, corresponding to the asset features 140 separated by a known distance f on the object 24 identified in the figure as part Pp. Once the facing direction θ is known, the image width [s] of a part feature, such as the image width of the distance g can be compared with the actual width of the distance g to determine the location of the object part Pp relative to the object tracker 24 and in the facility 10.

FIG. 17 shows how the previous created data, including a series of action entries 90 generated at various detected times 92 for a respective object 24, can be used to create a “sequence of operations” 114 being performed by the object 24. Referring to the illustrative example shown in FIG. 17, the object 24, which in the example is a forklift, is shown traveling through the facility 10 along an action path 40 including actions 40A, 40B, 40C performed by the object 24 forklift along the action path 40. In the illustrative example shown in FIG. 17, the first action 40A corresponds to a request for parts being acknowledged by the object 24 forklift. At the time the object 24 forklift acknowledges receipt of the request for parts P1, a data set [x, y, s, θ] is generated and timestamped for the object 24 forklift and saved as an action entry 90 associated with action 40A. The object 24 forklift travels along action path 40, during which time additional data sets [x, y, s, θ] are generated and timestamped and used to determine the location 96 and interactions of the object 24 forklift as it travels through the facility 10, which are saved as additional action entries 90. When a respective action entry 90 is generated which indicates that the object 24 forklift, for example, has approached a part carrier C1 containing the requested parts P1 at a direct angle, it is determined that the object 24 forklift has picked up the carrier C1 to complete action 40B at the detected time 92 associated with the respective action entry 90. Determining that action 40B “Step 2: Pick up parts” has been completed can include, by way of non-limiting example, comparing action entries 90 generated for the object 24 forklift and the parts carrier C1, to compare the relative positions and locations of these assets at various detected times 92, and to compare the interactions between the object 24 forklift and parts carrier Cl as recorded into the action entries 90 of the respective assets. When that same object 24 forklift carrying the parts carrier Cl then moves through the facility 10 along the action path 40, the path 40 is tracked with timestamped action entries generated for the object 24 forklift and/or the parts carrier C1 as these assets are detected in each of the detection zones 42 of the object trackers 12 located along the action path 40. When movement of the object 24 forklift away from the parts carrier C1 is detected via the series of action entries 90 generated for the object 24 forklift and parts carrier Cl by the object trackers 12 located along the action path 40, it can be determined that the action step 40C “Drop Off Parts” has been completed, including determining the time at which the action step 40C has been completed using the detected times 92 of the related action entries 90. When the parts carrier C1 is dropped off, e.g., is placed in the required location and ceases movement through the facility 10, the part request sequence ends. The sequence of operations 114 performed by the object 24 forklift can be displayed as shown in FIG. 17, including a heartbeat 110 showing an action event duration 108 for each action/operation 40A, 40B, 40C performed by the object 24 forklift in the part request sequence of operations 114. The heartbeat 110 and action event durations 108 can be used to determine an actual cycle time associated with each action 40A, 40B, 40C and a total actual cycle time for the sequence of operations 114 performed by the object 24 forklift. The heartbeat 110 can be used to establish a baseline cycle time and/or target cycle time against which future repetitions of the sequence of operations 114 can be compared, for the purpose of monitoring the performance cycle time and/or identifying improvement actions to optimize the cycle time and/or utilization of the forklift asset within the facility 24. The method and system illustrated in FIG. 17 is advantaged by using the plurality of object trackers (edge devices) 12 to generate a series of data sets [x, y, s, θ] which can be transmitted via the facility network 20 to transmit object ID numbers, locations, and timestamps, thus greatly reducing the amount of network bandwidth needed to generate the tracking data, including the sequence of operations 114 and heartbeat 110, associated with the actions performed by the object 24 forklift.

FIG. 18 illustrates a method of generating a virtual representation 142 of the facility 10 using the data, including the data sets [x, y, s, θ] collected by the object trackers 12 for objects 24 performing actions within the facility. In the example shown, using the localization data from FIG. 16 and sequencing data from FIG. 17, a virtual representation 142 of the facility 10 can be created and displayed, for example, via a display output 52 of a user device 50, as a virtual facility 10V. The data from FIG. 17, including, for example, the sequence 114 of action events 40A, 40B, 40C in a heartbeat display 110, can then be used to show where and when all of the different objects 24 are in the facility 10, and the interactions between the objects 24. The virtual representation 142 can be manipulated to view the current state of the facility 10 at any given (selected) time. This allows a user to see all of the object interactions in a facility 10 for tracking and troubleshooting purposes.

The example shown in FIGS. 17 and 18 is non-limiting, and it would be understood that each of the object trackers 12 operates to continuously generate data sets [x, y, s, θ] for each object 24 of a plurality of objects detected in their respective detection zone 42. The data sets [x, y, s, θ] and associated time stamps, asset ID, asset type, and interactions can be used to generate a plurality of different sequences of operations performed by the various objects 24 within the facility 10, such that the data sets [x, y, s, θ] collected from the various object trackers 12 can be used to map, monitor and quantify operations such as parts movement, carrier transport, etc., not readily tracked within a facility 10 by conventional means, and to generate a virtual representation of a facility 10 as shown in FIG. 18, in which the performance of sequences of operations can be displayed by virtual representation for analysis, monitoring, measurement and improvement planning

The following Clauses provide example configurations of a method and system for tracking actions of mobile assets used to perform a process within a facility, as disclosed herein.

Clause 1: A method for tracking actions of mobile assets used to perform a process within a facility, the method comprising: positioning an object tracker at a tracker location within the facility; providing a plurality of mobile assets to the facility; wherein each mobile asset includes an identifier which is unique to the mobile asset; wherein the mobile asset is associated in a database with the identifier, an asset ID and an asset type; wherein the object tracker defines a detection zone relative to the tracker location; wherein the object tracker includes: a sensor configured to collect sensor input within the detection zone; a tracker computer in communication with the sensor to receive the sensor input; and at least one algorithm for: time stamping the sensor input with a detection time; processing the sensor input to identify the identifier; processing the identifier to identify the asset ID and the asset type associated with the identifier; processing the sensor input to identify a location of the mobile asset at the detection time; and generating an asset entry including the asset ID, the asset type, the location of the mobile asset at the detection time, and the detection time; the method further comprising: the object tracker collecting, via the sensor, the sensor input wherein collecting the sensor input includes detecting the identifier when the mobile asset is located in the detection zone; the object tracker receiving, via the tracker computer, the sensor input; the object tracker time stamping, via the tracker computer, the sensor input with a detection time; the object tracker processing, via the tracker computer, the sensor input to identify the identifier; processing, via the tracker computer, the identifier to identify the asset ID and the asset type associated with the identifier; the object tracker processing the sensor input, via the tracker computer, to identify the location of the mobile asset at the detection time; and the object tracker generating, via the tracker computer, the asset entry; wherein the object tracker is in communication with a central data broker via a network, the method further comprising: the object tracker digitizing the asset entry using the tracker computer; the object tracker transmitting the digitized asset entry to the central data broker via the network.

Clause 2: The method of clause 1, further comprising: mapping the asset entry to an asset action list using the central data broker; and storing the asset action list to the database; wherein the asset entry and the asset action list are each associated with the asset ID and the asset type associated with the identifier.

Clause 3: The method of clause 2, further comprising: analyzing, via an analyst in communication with the database, the asset action list; wherein analyzing the asset action list comprises: determining an action event defined by the asset action list; determining an action event duration of the action event; and comparing the action event duration to a baseline duration.

Clause 4: The method of clause 2, further comprising: generating, via the analyst, a tracking map defined by the asset action list; wherein the tracking map visually displays at least one action performed by the mobile asset associated via the asset ID and asset type with the asset action list.

Clause 5: The method of clause 3, further comprising: generating, via the analyst, a heartbeat defined by the asset action list; wherein the heartbeat visually displays the action event duration and the action event.

Clause 6: The method of clause 5, wherein analyzing the asset action list comprises: determining a plurality of action events defined by the asset action list; and determining a respective action event duration for each action event of the plurality of action events; ordering the plurality of action events in a sequence according to time of occurrence; generating, via the analyst, the heartbeat; wherein the heartbeat visually displays the respective action event duration and the action event of each of the plurality of action events in the sequence.

Clause 7: The method of clause 2, further comprising: generating, via an analyst in communication with the database, a visualization display of the facility, the visualization display displaying the mobile asset at the location of the mobile asset at the detection time.

Clause 8: The method of clause 1, wherein: the object tracker is a first object tracker of a plurality of object trackers positioned within the facility; each objective tracker is positioned at a respective tracker location with the facility; the asset entry is a first asset entry including a first location of the mobile asset at a first detection time; the method further comprising: generating, via a second object tracker, a second asset entry including a second location of the mobile asset at a second detection time; digitizing the second asset entry using the tracker computer of the second object tracker; transmitting the digitized second asset entry to the central data broker via the network.

Clause 9: The method of clause 8, wherein: the first object tracker and the second object tracker are the same object tracker; the first detection time is different from the second detection time; and the first location is different from the second location; the method further comprising: generating, via an analyst in communication with the database, a tracking map displaying the first and second location of the mobile asset.

Clause 10: The method of clause 8, further comprising: generating, via an analyst in communication with the database, a visualization display of the facility, the visualization display displaying the movement of the mobile asset from the first location to the second location.

Clause 11: The method of clause 1, wherein the sensor comprises a camera; and wherein the sensor input is an image of the detection zone collected by the camera.

Clause 12: The method of clause 11, wherein the camera is an infrared sensitive camera.

Clause 13: The method of clause 1, wherein the object tracker is affixed to a structure of the facility, such that the object tracker is fixed in position.

Clause 14: The method of clause 1, wherein the object tracker is affixed to one of the mobile assets, such that the object tracker is mobile.

Clause 15: The method of clause 1, wherein the identifier is made of a reflective material or a retro-reflective material.

Clause 16: The method of clause 1, wherein the identifier includes at least one selected from the group of a label, a bar code, a QR code, an asset feature, an asset dimension, a fiducial feature, a facial keypoint, a pattern, and a shape, each of these affixed to or defined by the mobile asset.

Clause 17: The method of clause 1, wherein the mobile asset includes a plurality of identifiers; at least one identifier of the plurality of identifiers including a pattern defined by a combination of the plurality of identifiers.

Clause 18: The method of clause 1, further comprising: affixing, to the mobile asset, a plurality of labels in a known arrangement to define a pattern; wherein the identifier is defined by the pattern.

Clause 19: The method of clause 1, wherein the mobile asset includes an asset feature characterized by an asset dimension; wherein the identifier is defined by the asset dimension.

Clause 20: The method of clause 1, wherein the mobile asset includes an asset feature characterized by a feature shape; wherein the identifier is defined by the feature shape.

Clause 21: The method of clause 1, wherein the mobile asset includes a plurality of asset features in a known arrangement; wherein the identifier is defined by the known arrangement of the plurality of asset features.

Clause 22: The method of clause 1, wherein the identifier is configured as a fiducial feature.

Clause 23: The method of clause 1, wherein the identifier is a standardized identifier characterized by a known shape and size; the method further comprising: affixing the standardized identifier to the mobile asset in a known position and known orientation relative to the mobile asset; wherein the known position and known orientation is associated in the database with the mobile asset.

Clause 24: The method of clause 1, wherein: the identifier includes a first reference point at a first known position and a second reference point at a second known position such that the first reference point is located at a known distance from the second reference point; the sensor input includes an image of the mobile asset including the identifier; the method further comprising: analyzing, via the tracker computer, the image of the mobile asset including the identifier to determine a pose of the mobile asset at the detection time, wherein analyzing the image includes: determining a first image position of the first reference point in the image; determining a second image position of the second reference point in the image; determining an image distance between the first image position and the second image position; comparing the image distance and the known distance; and determining a facing direction of the identifier using the comparison of the image distance and the known distance.

Clause 25: The method of clause 24, further comprising: determining a facing direction of the mobile asset using the facing direction of the identifier; determining an observed dimension of an asset feature of the mobile asset from the image of the mobile asset; comparing the observed dimension of the asset feature and a known asset dimension of the asset feature; and determining the location of the mobile asset in the facility, using the comparison of the observed dimension and the known asset dimension.

Clause 26: The method of clause 24, wherein the asset feature is a front edge of the mobile asset.

Clause 27: The method of clause 24, wherein analyzing the image further includes: determining a bounding box defined by the identifier; determining a bounded center of the bounding box; determining a center of mass of the image of the identifier; wherein the first reference point is the bounded center; wherein the second reference point is the center of mass; the method further comprising: determining the facing direction of the identifier by comparing: the known distance between the bounded center and the center of mass of the identifier to the image distance between the bounded center and the center of mass of the image; determining the facing direction of the identifier using the comparison.

Clause 28: A system for tracking actions of mobile assets used to perform a process within a facility, the system comprising: an object tracker positioned at a tracker location within a facility; a plurality of mobile assets located within the facility; wherein each mobile asset includes an identifier which is unique to the mobile asset; wherein the mobile asset is associated in a database with the identifier, an asset ID and an asset type; wherein the object tracker defines a detection zone relative to the tracker location; wherein the object tracker includes: a sensor configured to collect sensor input within the detection zone; wherein collecting the sensor input includes detecting the identifier when the mobile asset is located in the detection zone; a tracker computer in communication with the sensor to receive the sensor input; and at least one algorithm for: time stamping the sensor input with a detection time; processing the sensor input to identify the identifier; processing the identifier to identify the asset ID and the asset type associated with the identifier; processing the sensor input to identify a location of the mobile asset at the detection time; and generating an asset entry including the asset ID, the asset type, the location of the mobile asset at the detection time, and the detection time; the system further comprising: a central broker in communication with the object tracker; the object tracker further configured to: digitize the asset entry using the tracking computer; transmit the digitized asset entry to the central data broker via the network; the central broker configured to store the digitized asset entry to the database.

Clause 29: The system of clause 28, wherein the central broker is configured to: map the asset entry to an asset action list using the central data broker; and store the asset action list to the database; wherein the asset entry and the asset action list are each associated with the asset ID and the asset type associated with the identifier.

Clause 30: The system of clauses 28, further comprising: an analyst in communication with the database; the analyst configured to analyze the asset action list; wherein analyzing the asset action list comprises: determining an action event defined by the asset action list; determining an action event duration of the action event; and comparing the action event duration to a baseline duration.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of ‘comprising’ and “including” to provide more specific embodiments and are also disclosed. As used in this disclosure and in the appended claims, the singular forms “a”, “an”, “the”, include plural referents unless the context clearly dictates otherwise.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A method for tracking actions of mobile assets used to perform a process within a facility, the method comprising:
positioning an object tracker at a tracker location within the facility;
providing a plurality of mobile assets to the facility;
wherein each mobile asset includes an identifier which is unique to the mobile asset;
wherein the mobile asset is associated in a database with the identifier, an asset ID and an asset type;
wherein the object tracker defines a detection zone relative to the tracker location;
wherein the object tracker includes:
a sensor configured to collect sensor input within the detection zone;
a tracker computer in communication with the sensor to receive the sensor input; and
at least one algorithm for:
time stamping the sensor input with a detection time;
processing the sensor input to identify the identifier;
processing the identifier to identify the asset ID and the asset type associated with the identifier;
processing the sensor input to identify a location of the mobile asset at the detection time; and
generating an asset entry including the asset ID, the asset type, the location of the mobile asset at the detection time, and the detection time;
the method further comprising:
the object tracker collecting, via the sensor, the sensor input wherein collecting the sensor input includes detecting the identifier when the mobile asset is located in the detection zone;
the object tracker receiving, via the tracker computer, the sensor input;
the object tracker time stamping, via the tracker computer, the sensor input with a detection time;
the object tracker processing, via the tracker computer, the sensor input to identify the identifier;
processing, via the tracker computer, the identifier to identify the asset ID and the asset type associated with the identifier;
the object tracker processing the sensor input, via the tracker computer, to identify the location of the mobile asset at the detection time; and
the object tracker generating, via the tracker computer, the asset entry;
wherein the object tracker is in communication with a central data broker via a network, the method further comprising:
the object tracker digitizing the asset entry using the tracker computer;
the object tracker transmitting the digitized asset entry to the central data broker via the network.

2. The method of claim 1, further comprising:
mapping the asset entry to an asset action list using the central data broker; and
storing the asset action list to the database;
wherein the asset entry and the asset action list are each associated with the asset ID and the asset type associated with the identifier.

3. The method of claim 2, further comprising:
analyzing, via an analyst in communication with the database, the asset action list;
wherein analyzing the asset action list comprises:
determining an action event defined by the asset action list;
determining an action event duration of the action event; and
comparing the action event duration to a baseline duration.

4. The method of claim 2, further comprising:
generating, via the analyst, a tracking map defined by the asset action list;
wherein the tracking map visually displays at least one action performed by the mobile asset associated via the asset ID and asset type with the asset action list.

5. The method of claim 3, further comprising:
generating, via the analyst, a heartbeat defined by the asset action list;
wherein the heartbeat visually displays the action event duration and the action event.

6. The method of claim 5, wherein analyzing the asset action list comprises:
determining a plurality of action events defined by the asset action list; and
determining a respective action event duration for each action event of the plurality of action events;
ordering the plurality of action events in a sequence according to time of occurrence;
generating, via the analyst, the heartbeat;
wherein the heartbeat visually displays the respective action event duration and the action event of each of the plurality of action events in the sequence.

7. The method of claim 2, further comprising:
generating, via an analyst in communication with the database, a visualization display of the facility, the visualization display displaying the mobile asset at the location of the mobile asset at the detection time.

8. The method of claim 1, wherein:
the object tracker is a first object tracker of a plurality of object trackers positioned within the facility;
each objective tracker is positioned at a respective tracker location with the facility;
the asset entry is a first asset entry including a first location of the mobile asset at a first detection time;
the method further comprising:
generating, via a second object tracker, a second asset entry including a second location of the mobile asset at a second detection time;
digitizing the second asset entry using the tracker computer of the second object tracker;
transmitting the digitized second asset entry to the central data broker via the network.

9. The method of claim 8, wherein:
the first object tracker and the second object tracker are the same object tracker;
the first detection time is different from the second detection time; and
the first location is different from the second location;
the method further comprising:
generating, via an analyst in communication with the database, a tracking map displaying the first and second location of the mobile asset.

10. The method of claim 8, further comprising:
generating, via an analyst in communication with the database, a visualization display of the facility, the visualization display displaying the movement of the mobile asset from the first location to the second location.

11. The method of claim 1, wherein the sensor comprises a camera; and
wherein the sensor input is an image of the detection zone collected by the camera.

12. The method of claim 11, wherein the camera is an infrared sensitive camera.

13. The method of claim 1, wherein the object tracker is affixed to a structure of the facility, such that the object tracker is fixed in position.

14. The method of claim 1, wherein the object tracker is affixed to one of the mobile assets, such that the object tracker is mobile.

15. The method of claim 1, wherein the identifier is made of a reflective material or a retro-reflective material.

16. The method of claim 1, wherein the identifier includes at least one selected from the group of a label, a bar code, a QR code, an asset feature, an asset dimension, a fiducial feature, a facial keypoint, a pattern, and a shape, each of these affixed to or defined by the mobile asset.

17. The method of claim 1, wherein the mobile asset includes a plurality of identifiers;
at least one identifier of the plurality of identifiers including a pattern defined by a combination of the plurality of identifiers.

18. The method of claim 1, further comprising:
affixing, to the mobile asset, a plurality of labels in a known arrangement to define a pattern;
wherein the identifier is defined by the pattern.

19. The method of claim 1, wherein the mobile asset includes an asset feature characterized by an asset dimension;
wherein the identifier is defined by the asset dimension.

20. The method of claim 1, wherein the mobile asset includes an asset feature characterized by a feature shape;
wherein the identifier is defined by the feature shape.

21. The method of claim 1, wherein the mobile asset includes a plurality of asset features in a known arrangement;
wherein the identifier is defined by the known arrangement of the plurality of asset features.

22. The method of claim 1, wherein the identifier is configured as a fiducial feature.

23. The method of claim 1, wherein the identifier is a standardized identifier characterized by a known shape and size;
the method further comprising:
affixing the standardized identifier to the mobile asset in a known position and known orientation relative to the mobile asset;
wherein the known position and known orientation is associated in the database with the mobile asset.

24. The method of claim 1, wherein:
the identifier includes a first reference point at a first known position and a second reference point at a second known position such that the first reference point is located at a known distance from the second reference point;
the sensor input includes an image of the mobile asset including the identifier;
the method further comprising:
analyzing, via the tracker computer, the image of the mobile asset including the identifier to determine a pose of the mobile asset at the detection time, wherein analyzing the image includes:
determining a first image position of the first reference point in the image;
determining a second image position of the second reference point in the image;
determining an image distance between the first image position and the second image position;
comparing the image distance and the known distance; and
determining a facing direction of the identifier using the comparison of the image distance and the known distance.

25. The method of claim 24, further comprising:
determining a facing direction of the mobile asset using the facing direction of the identifier;
determining an observed dimension of an asset feature of the mobile asset from the image of the mobile asset;
comparing the observed dimension of the asset feature and a known asset dimension of the asset feature; and
determining the location of the mobile asset in the facility, using the comparison of the observed dimension and the known asset dimension.

26. The method of claim 24, wherein the asset feature is a front edge of the mobile asset.

27. The method of claim 24, wherein analyzing the image further includes:
determining a bounding box defined by the identifier;
determining a bounded center of the bounding box;
determining a center of mass of the image of the identifier;
wherein the first reference point is the bounded center;
wherein the second reference point is the center of mass;
the method further comprising:
determining the facing direction of the identifier by comparing:
the known distance between the bounded center and the center of mass of the identifier to the image distance between the bounded center and the center of mass of the image;
determining the facing direction of the identifier using the comparison.

28. A system for tracking actions of mobile assets used to perform a process within a facility, the system comprising:
an object tracker positioned at a tracker location within a facility;
a plurality of mobile assets located within the facility;
wherein each mobile asset includes an identifier which is unique to the mobile asset;
wherein the mobile asset is associated in a database with the identifier, an asset ID and an asset type;
wherein the object tracker defines a detection zone relative to the tracker location;
wherein the object tracker includes:
a sensor configured to collect sensor input within the detection zone;
wherein collecting the sensor input includes detecting the identifier when the mobile asset is located in the detection zone;
a tracker computer in communication with the sensor to receive the sensor input; and
at least one algorithm for:
time stamping the sensor input with a detection time;
processing the sensor input to identify the identifier;
processing the identifier to identify the asset ID and the asset type associated with the identifier;
processing the sensor input to identify a location of the mobile asset at the detection time; and
generating an asset entry including the asset ID, the asset type, the location of the mobile asset at the detection time, and the detection time;
the system further comprising:
a central broker in communication with the object tracker;
the object tracker further configured to:
digitize the asset entry using the tracking computer;
transmit the digitized asset entry to the central data broker via the network;
the central broker configured to store the digitized asset entry to the database.

29. The system of claim 28, wherein the central broker is configured to:
map the asset entry to an asset action list using the central data broker; and
store the asset action list to the database;
wherein the asset entry and the asset action list are each associated with the asset ID and the asset type associated with the identifier.

30. The system of claims 28, further comprising:
an analyst in communication with the database;
the analyst configured to analyze the asset action list;
wherein analyzing the asset action list comprises:
determining an action event defined by the asset action list;
determining an action event duration of the action event; and
comparing the action event duration to a baseline duration.
